(19) United States
(12) Patent Application Publication
(10) Pub. No.: US 2026/0197450 A1
(43) Pub. Date: Jul. 9, 2026

(54) METHOD, APPARATUS, AND MEDIUM FOR VISUAL DATA PROCESSING

(71) Applicant: Bytedance Inc., Los Angeles, CA (US)

(72) Inventors: Semih ESENLIK, Los Angeles, CA (US); Zhaobin ZHANG, Los Angeles, CA (US); Kai ZHANG, Los Angeles, CA (US); Li ZHANG, Los Angeles, CA (US)

(21) Appl. No.: 19/553,102

(22) Filed: Feb. 27, 2026

Related U.S. Application Data
(63) Continuation of application No. PCT/US2024/044602, filed on Aug. 30, 2024.
(60) Provisional application No. 63/579,801, filed on Aug. 30, 2023.

(51) Int. Cl. H04N 19/117; H04N 19/186; H04N 19/189; H04N 19/30

(52) U.S. Cl. CPC H04N 19/117; H04N 19/186; H04N 19/189; H04N 19/30

(57) ABSTRACT

Embodiments of the present disclosure provide a solution for visual data processing. A method for visual data processing is proposed. The method comprises: obtaining, for a conversion between visual data and a bitstream of the visual data with a neural network (NN)-based model, at least one intermediate representation of the visual data in the NN-based model; applying a first filter in the NN-based model on the at least one intermediate representation, at least one parameter of the first filter being configured based on a format of output visual data from the conversion, the format indicating a relationship between a size of a first component of the output visual data and a size of a second component of the output visual data; and performing the conversion based on the applying.

### CROSS REFERENCE TO RELATED APPLICATIONS

This application is a continuation of International Application No. PCT/US2024/044602, filed on Aug. 30, 2024, which claims the benefit of U.S. Provisional Application No. 63/579,801, filed on Aug. 30, 2023. The entire contents of these applications are hereby incorporated by reference in their entireties.

### FIELDS

Embodiments of the present disclosure relates generally to visual data processing techniques, and more particularly, to neural network-based visual data coding.

### BACKGROUND

The past decade has witnessed the rapid development of deep learning in a variety of areas, especially in computer vision and image processing. Neural network was invented originally with the interdisciplinary research of neuroscience and mathematics. It has shown strong capabilities in the context of non-linear transform and classification. Neural network-based image/video compression technology has gained significant progress during the past half decade. It is reported that the latest neural network-based image compression algorithm achieves comparable rate-distortion (R-D) performance with Versatile Video Coding (VVC). With the performance of neural image compression continually being improved, neural network-based video compression has become an actively developing research area. However, coding efficiency of neural network-based image/video coding is generally expected to be further improved.

### SUMMARY

Embodiments of the present disclosure provide a solution for visual data processing.

In a first aspect, a method for visual data processing is proposed. The method comprises: obtaining, for a conversion between visual data and a bitstream of the visual data with a neural network (NN)-based model, at least one intermediate representation of the visual data in the NN-based model; applying a first filter in the NN-based model on the at least one intermediate representation, at least one parameter of the first filter being configured based on a format of output visual data from the conversion, the format indicating a relationship between a size of a first component of the output visual data and a size of a second component of the output visual data; and performing the conversion based on the applying.

Based on the method in accordance with the first aspect of the present disclosure, a parameter(s) of a first filter applied on the at least one intermediate representation of the visual data is configured based on a format of the output visual data. Compared with the conventional solution where the parameter of the first filter is fixed, the proposed solution can advantageously support different output format, so as to cater different applications. Thereby, the coding flexibility can be improved and thus the coding efficiency can be enhanced.

In a second aspect, an apparatus for visual data processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of visual data which is generated by a method performed by an apparatus for visual data processing. The method comprises: obtaining at least one intermediate representation of the visual data in a neural network (NN)-based model; applying a first filter in the NN-based model on the at least one intermediate representation, at least one parameter of the first filter being configured based on a format of output visual data from the conversion, the format indicating a relationship between a size of a first component of the output visual data and a size of a second component of the output visual data; and generating the bitstream with the NN-based model based on the applying.

In a fifth aspect, a method for storing a bitstream of visual data is proposed. The method comprises: obtaining at least one intermediate representation of the visual data in a neural network (NN)-based model; applying a first filter in the NN-based model on the at least one intermediate representation, at least one parameter of the first filter being configured based on a format of output visual data from the conversion, the format indicating a relationship between a size of a first component of the output visual data and a size of a second component of the output visual data; generating the bitstream with the NN-based model based on the applying; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1A illustrates a block diagram that illustrates an example visual data coding system, in accordance with some embodiments of the present disclosure;

FIG. 1B is a schematic diagram illustrating an example transform coding scheme;

FIG. 2 illustrates example latent representations of an image;

FIG. 3 is a schematic diagram illustrating an example autoencoder implementing a hyperprior model;

FIG. 4 is a schematic diagram illustrating an example combined model configured to jointly optimize a context model along with a hyperprior and the autoencoder;

FIG. 5 illustrates an example encoding process;

FIG. 6 illustrates an example decoding process;

FIG. 7 illustrates an example decoding process according to some embodiments of the present disclosure;

FIG. 8 illustrates an example learning-based image codec architecture;

FIG. 9 illustrates an example synthesis transform for learning based image coding;

FIG. 10 illustrates an example LeakyReLU activation function;

FIG. 11 illustrates an example ReLU activation function;

FIG. 12 is a flowchart for an example method of visual data processing in accordance with embodiments of the present disclosure;

FIG. 13 is a flowchart for an example method of visual data processing in accordance with embodiments of the present disclosure;

FIG. 14 is a flowchart for an example method of visual data processing in accordance with embodiments of the present disclosure;

FIG. 15 is a flowchart for an example method of visual data processing in accordance with embodiments of the present disclosure;

FIG. 16 illustrates an example neural network in accordance with embodiments of the present disclosure;

FIG. 17 illustrates an example neural network in accordance with embodiments of the present disclosure;

FIG. 18 illustrates a block diagram showing a down-sampling process in accordance with embodiments of the present disclosure;

FIG. 19 illustrates a flowchart of a method for visual data processing in accordance with embodiments of the present disclosure; and

FIG. 20 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

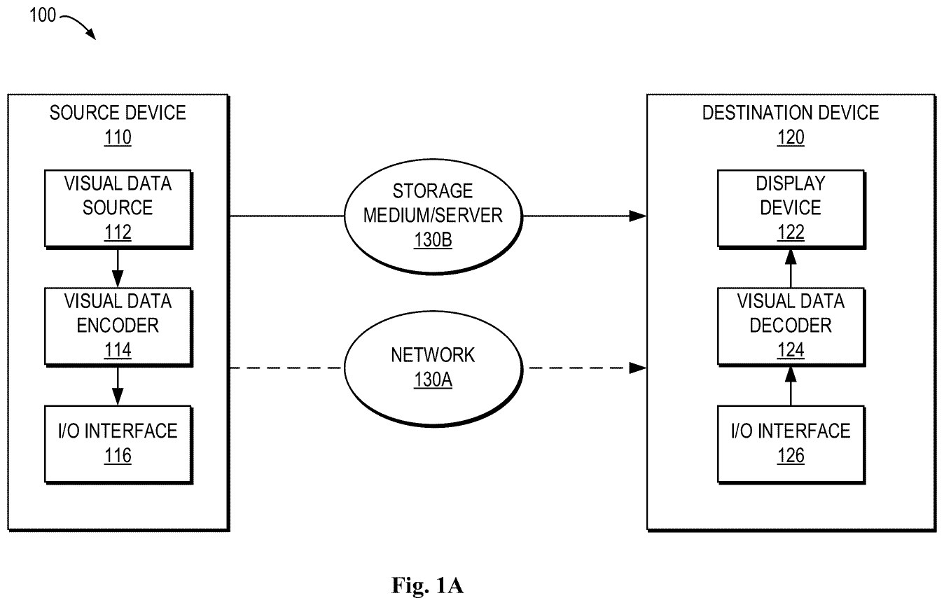

FIG. 1A is a block diagram that illustrates an example visual data coding system 100 that may utilize the techniques of this disclosure. As shown, the visual data coding system 100 may include a source device 110 and a destination device 120. The source device 110 can be also referred to as a visual data encoding device, and the destination device 120 can be also referred to as a visual data decoding device. In operation, the source device 110 can be configured to generate encoded visual data and the destination device 120 can be configured to decode the encoded visual data generated by the source device 110. The source device 110 may include a visual data source 112, a visual data encoder 114, and an input/output (I/O) interface 116.

The visual data source 112 may include a source such as a visual data capture device. Examples of the visual data capture device include, but are not limited to, an interface to receive visual data from a visual data provider, a computer graphics system for generating visual data, and/or a combination thereof.

The visual data may comprise one or more pictures of a video or one or more images. The visual data encoder 114 encodes the visual data from the visual data source 112 to generate a bitstream. The bitstream may include a sequence of bits that form a coded representation of the visual data. The bitstream may include coded pictures and associated visual data. The coded picture is a coded representation of a picture. The associated visual data may include sequence parameter sets, picture parameter sets, and other syntax structures. The I/O interface 116 may include a modulator/demodulator and/or a transmitter. The encoded visual data may be transmitted directly to destination device 120 via the I/O interface 116 through the network 130A. The encoded visual data may also be stored onto a storage medium/server 130B for access by destination device 120.

The destination device 120 may include an I/O interface 126, a visual data decoder 124, and a display device 122. The I/O interface 126 may include a receiver and/or a modem. The I/O interface 126 may acquire encoded visual data from the source device 110 or the storage medium/server 130B. The visual data decoder 124 may decode the encoded visual data. The display device 122 may display the decoded visual data to a user. The display device 122 may be integrated with the destination device 120, or may be external to the destination device 120 which is configured to interface with an external display device.

The visual data encoder 114 and the visual data decoder 124 may operate according to a visual data coding standard, such as video coding standard or still picture coding standard and other current and/or further standards.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific visual data codecs, the disclosed techniques are applicable to other coding technologies also. Furthermore, while some embodiments describe coding steps in detail, it will be understood that corresponding steps decoding that undo the coding will be implemented by a decoder. Furthermore, the term visual data processing encompasses visual data coding or compression, visual data decoding or decompression and visual data transcoding in which visual data are represented from one compressed format into another compressed format or at a different compressed bitrate.

### 1. Initial Discussion

This patent document is related to a neural network-based image and video compression approach employing modification of components of an image using adaptive filtering layers. This includes a determination of whether the value of a sample of a first component is based on the value of a sample of the second component.

### 2. Further Discussion

Deep learning is developing in a variety of areas, such as in computer vision and image processing. Inspired by the successful application of deep learning technology to computer vision areas, neural image/video compression technologies are being studied for application to image/video compression techniques. The neural network is designed based on interdisciplinary research of neuroscience and mathematics. The neural network has shown strong capabilities in the context of non-linear transform and classification. An example neural network-based image compression algorithm achieves comparable R-D performance with Versatile Video Coding (VVC), which is a video coding standard developed by the Joint Video Experts Team (JVET) with experts from motion picture experts group (MPEG) and Video coding experts group (VCEG). Neural network-based video compression is an actively developing research area resulting in continuous improvement of the performance of neural image compression. However, neural network-based video coding is still a largely undeveloped discipline due to the inherent difficulty of the problems addressed by neural networks.

### 2.1 Image/Video Compression

Image/video compression usually refers to a computing technology that compresses video images into binary code to facilitate storage and transmission. The binary codes may or may not support losslessly reconstructing the original image/video. Coding without data loss is known as lossless compression and coding while allowing for targeted loss of data in known as lossy compression, respectively. Most coding systems employ lossy compression since lossless reconstruction is not necessary in most scenarios. Usually the performance of image/video compression algorithms is evaluated based on a resulting compression ratio and reconstruction quality. Compression ratio is directly related to the number of binary codes resulting from compression, with fewer binary codes resulting in better compression. Reconstruction quality is measured by comparing the reconstructed image/video with the original image/video, with greater similarity resulting in better reconstruction quality.

Image/video compression techniques can be divided into video coding methods and neural-network-based video compression methods. Video coding schemes adopt transform-based solutions, in which statistical dependency in latent variables, such as discrete cosine transform (DCT) and wavelet coefficients, is employed to carefully hand-engineer entropy codes to model the dependencies in the quantized regime. Neural network-based video compression can be grouped into neural network-based coding tools and end-to-end neural network-based video compression. The former is embedded into existing video codecs as coding tools and only serves as part of the framework, while the latter is a separate framework developed based on neural networks without depending on video codecs.

A series of video coding standards have been developed to accommodate the increasing demands of visual content transmission. The international organization for standardization (ISO)/International Electrotechnical Commission (IEC) has two expert groups, namely Joint Photographic Experts Group (JPEG) and Moving Picture Experts Group (MPEG). International Telecommunication Union (ITU) telecommunication standardization sector (ITU-T) also has a Video Coding Experts Group (VCEG), which is for standardization of image/video coding technology. The influential video coding standards published by these organizations include Joint Photographic Experts Group (JPEG), JPEG 2000, H.262, H.264/advanced video coding (AVC) and H.265/High Efficiency Video Coding (HEVC). The Joint Video Experts Team (JVET), formed by MPEG and VCEG, developed the Versatile Video Coding (VVC) standard. An average of 50% bitrate reduction is reported by VVC under the same visual quality compared with HEVC.

Neural network-based image/video compression/coding is also under development. Example neural network coding network architectures are relatively shallow, and the performance of such networks is not satisfactory. Neural network-based methods benefit from the abundance of data and the support of powerful computing resources, and are therefore better exploited in a variety of applications. Neural network-based image/video compression has shown promising improvements and is confirmed to be feasible. Nevertheless, this technology is far from mature and a lot of challenges should be addressed.

### 2.2 Neural Networks

Neural networks, also known as artificial neural networks (ANN), are computational models used in machine learning technology. Neural networks are usually composed of multiple processing layers, and each layer is composed of multiple simple but non-linear basic computational units. One benefit of such deep networks is a capacity for processing data with multiple levels of abstraction and converting data into different kinds of representations. Representations created by neural networks are not manually designed. Instead, the deep network including the processing layers is learned from massive data using a general machine learning procedure. Deep learning eliminates the necessity of handcrafted representations. Thus, deep learning is regarded useful especially for processing natively unstructured data, such as acoustic and visual signals. The processing of such data has been a longstanding difficulty in the artificial intelligence field.

### 2.3 Neural Networks for Image Compression

Neural networks for image compression can be classified in two categories, including pixel probability models and auto-encoder models. Pixel probability models employ a predictive coding strategy. Auto-encoder models employ a transform-based solution. Sometimes, these two methods are combined together.

### 2.3.1 Pixel Probability Modeling

According to Shannon's information theory, the optimal method for lossless coding can reach the minimal coding rate, which is denoted as −log 2 p(x) where p(x) is the probability of symbol x. Arithmetic coding is a lossless coding method that is believed to be among the optimal methods. Given a probability distribution p(x), arithmetic coding causes the coding rate to be as close as possible to a theoretical limit −log 2 p(x) without considering the rounding error. Therefore, the remaining problem is to determine the probability, which is very challenging for natural image/video due to the curse of dimensionality. The curse of dimensionality refers to the problem that increasing dimensions causes data sets to become sparse, and hence rapidly increasing amounts of data is needed to effectively analyze and organize data as the number of dimensions increases.

Following the predictive coding strategy, one way to model p(x) is to predict pixel probabilities one by one in a raster scan order based on previous observations, where x is an image, can be expressed as follows:

$$p ( x ) = p ( {x}_{1} ) p ( {x}_{2} \vert {x}_{1} ) ... p ( {x}_{i} \vert {x}_{1} , ... , {x}_{i - 1} ) ... p ( {x}_{m \times n} \vert {x}_{1} , ... , {x}_{m \times n - 1} ) \qquad ( 1 )$$

where m and n are the height and width of the image, respectively. The previous observation is also known as the context of the current pixel. When the image is large, estimation of the conditional probability can be difficult. Thereby, a simplified method is to limit the range of the context of the current pixel as follows:

$$p ( x ) = p ( {x}_{1} ) p ( {x}_{2} \vert {x}_{1} ) ... p ( {x}_{i} \vert {x}_{i - k} , ... , {x}_{i - 1} ) ... p ( {x}_{m \times n} \vert {x}_{m \times n - k} , ... , {x}_{m \times n - 1} ) \qquad ( 2 )$$

where k is a pre-defined constant controlling the range of the context.

It should be noted that the condition may also take the sample values of other color components into consideration. For example, when coding the red (R), green (G), and blue (B) (RGB) color component, the R sample is dependent on previously coded pixels (including R, G, and/or B samples), the current G sample may be coded according to previously coded pixels and the current R sample. Further, when coding the current B sample, the previously coded pixels and the current R and G samples may also be taken into consideration.

Neural networks may be designed for computer vision tasks, and may also be effective in regression and classification problems. Therefore, neural networks may be used to estimate the probability of p(xᵢ) given a context x₁, x₂, . . . , xᵢ₋₁.

Most of the methods directly model the probability distribution in the pixel domain. Some designs also model the probability distribution as conditional based upon explicit or latent representations. Such a model can be expressed as:

$$p ( x \vert h ) = {\prod }_{i = 1}^{m \times n} p ( {x}_{i} \vert {x}_{1} , ... , {x}_{i - 1} , h ) \qquad ( 3 )$$

where h is the additional condition and p(x)=p(h)p(x|h) indicates the modeling is split into an unconditional model and a conditional model. The additional condition can be image label information or high-level representations.

### 2.3.2 Auto-Encoder

An Auto-encoder is now described. The auto-encoder is trained for dimensionality reduction and include an encoding component and a decoding component. The encoding component converts the high-dimension input signal to low-dimension representations. The low-dimension representations may have reduced spatial size, but a greater number of channels. The decoding component recovers the high-dimension input from the low-dimension representation. The auto-encoder enables automated learning of representations and eliminates the need of hand-crafted features, which is also believed to be one of the most important advantages of neural networks.

FIG. 1B is a schematic diagram illustrating an example transform coding scheme. The original image x is transformed by the analysis network gₐ to achieve the latent representation y. The latent representation y is quantized (q) and compressed into bits. The number of bits R is used to measure the coding rate. The quantized latent representation ŷ is then inversely transformed by a synthesis network gₛ to obtain the reconstructed image \hat{x}. The distortion (D) is calculated in a perceptual space by transforming x and \hat{x} with the function gₚ, resulting in z and \hat{z}, which are compared to obtain D.

An auto-encoder network can be applied to lossy image compression. The learned latent representation can be encoded from the well-trained neural networks. However, adapting the auto-encoder to image compression is not trivial since the original auto-encoder is not optimized for compression, and is thereby not efficient for direct use as a trained auto-encoder. In addition, other major challenges exist. First, the low-dimension representation should be quantized before being encoded. However, the quantization is not differentiable, which is required in backpropagation while training the neural networks. Second, the objective under a compression scenario is different since both the distortion and the rate need to be take into consideration. Estimating the rate is challenging. Third, a practical image coding scheme should support variable rate, scalability, encoding/decoding speed, and interoperability. In response to these challenges, various schemes are under development.

An example auto-encoder for image compression using the example transform coding scheme can be regarded as a transform coding strategy. The original image x is transformed with the analysis network y=gₐ(x), where y is the latent representation to be quantized and coded. The synthesis network inversely transforms the quantized latent representation ŷ back to obtain the reconstructed image \hat{x}=gₛ(ŷ). The framework is trained with the rate-distortion loss function, [symbol] =D+λR, where D is the distortion between x and \hat{x}, R is the rate calculated or estimated from the quantized representation ŷ, and λ is the Lagrange multiplier. D can be calculated in either pixel domain or perceptual domain. Most example systems follow this prototype and the differences between such systems might only be the network structure or loss function.

### 2.3.3 Hyper Prior Model

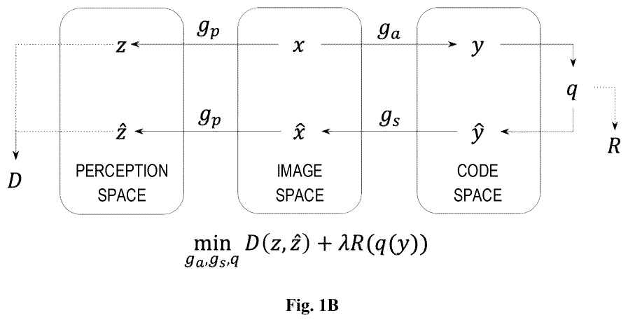

FIG. 2 illustrates example latent representations of an image. FIG. 2 includes an image 201 from the Kodak dataset, a visualization of the latent 202 representation y of the image 201, a standard deviations σ 203 of the latent 202, and latents y 204 after a hyper prior network is introduced. A hyper prior network includes a hyper encoder and decoder. In the transform coding approach to image compression, as shown in FIG. 1B, the encoder subnetwork transforms the image vector x using a parametric analysis transform gₐ(x, Ø_{g}) into a latent representation y, which is then quantized to form ŷ. Because ŷ is discrete-valued, ŷ can be losslessly compressed using entropy coding techniques such as arithmetic coding and transmitted as a sequence of bits.

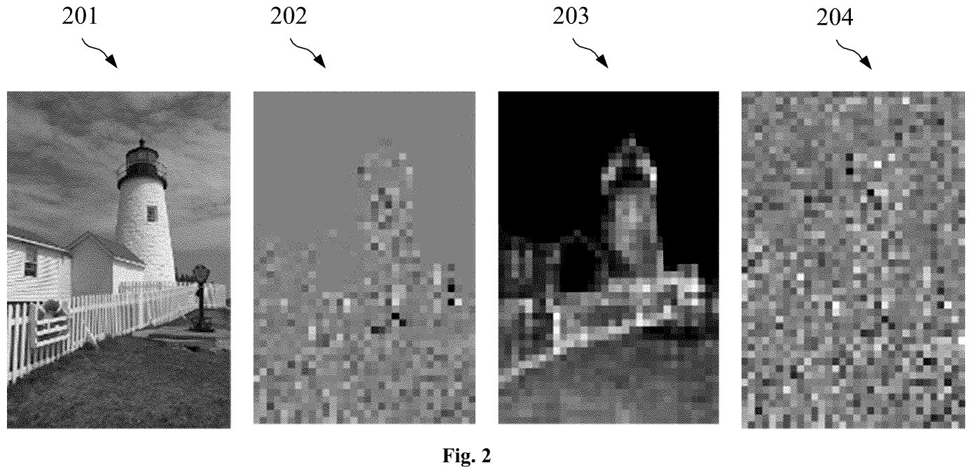

As evident from the latent 202 and the standard deviations σ 203 of FIG. 2, there are significant spatial dependencies among the elements of ŷ. Notably, their scales (standard deviations σ 203) appear to be coupled spatially. An additional set of random variables \hat{z} may be introduced to capture the spatial dependencies and to further reduce the redundancies. In this case the image compression network is depicted in FIG. 3.

FIG. 3 is a schematic diagram illustrating an example network architecture of an autoencoder implementing a hyperprior model. The upper side shows an image autoencoder network, and the lower side corresponds to the hyperprior subnetwork. The analysis and synthesis transforms are denoted as gₐ and gₐ. Q represents quantization, and AE, AD represent arithmetic encoder and arithmetic decoder, respectively. The hyperprior model includes two subnetworks, hyper encoder (denoted with hₐ) and hyper decoder (denoted with hₛ). The hyper prior model generates a quantized hyper latent (\hat{z}) which comprises information related to the probability distribution of the samples of the quantized latent ŷ. \hat{z} is included in the bitstream and transmitted to the receiver (decoder) along with ŷ.

In FIG. 3, the upper side of the models is the encoder gₐ and decoder gₛ as discussed above. The lower side is the additional hyper encoder hₐ and hyper decoder hₛ networks that are used to obtain \hat{z}. In this architecture the encoder subjects the input image x to gₐ, yielding the responses y with spatially varying standard deviations. The responses y are fed into hₐ, summarizing the distribution of standard deviations in z. z is then quantized (\hat{z}), compressed, and transmitted as side information. The encoder then uses the quantized vector \hat{z} to estimate σ, the spatial distribution of standard deviations, and uses σ to compress and transmit the quantized image representation ŷ. The decoder first recovers 2 from the compressed signal. The decoder then uses hₛ to obtain σ, which provides the decoder with the correct probability estimates to successfully recover ŷ as well. The decoder then feeds ŷ into gₛ to obtain the reconstructed image.

When the hyper encoder and hyper decoder are added to the image compression network, the spatial redundancies of the quantized latent ŷ are reduced. The latents y 204 in FIG. 2 correspond to the quantized latent when the hyper encoder/decoder are used. Compared to the standard deviations σ 203, the spatial redundancies are significantly reduced as the samples of the quantized latent are less correlated.

### 2.3.4 Context Model

Although the hyper prior model improves the modelling of the probability distribution of the quantized latent ŷ, additional improvement can be obtained by utilizing an autoregressive model that predicts quantized latents from their causal context, which may be known as a context model.

The term auto-regressive indicates that the output of a process is later used as an input to the process. For example, the context model subnetwork generates one sample of a latent, which is later used as input to obtain the next sample.

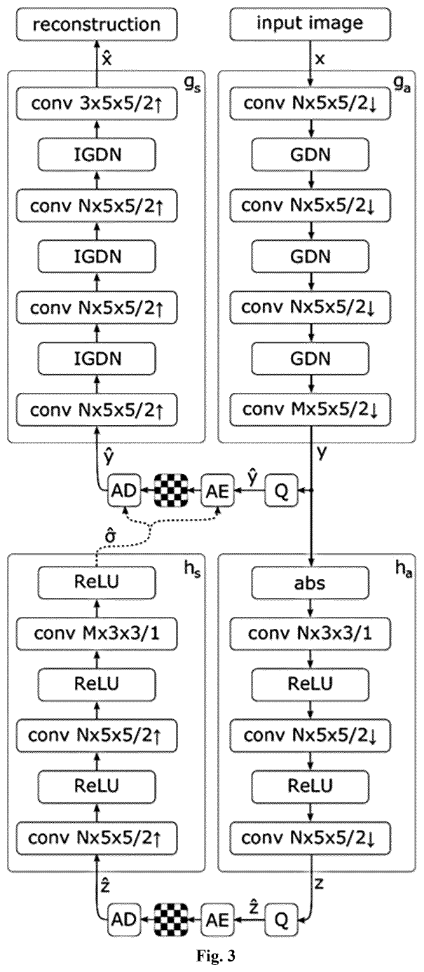

FIG. 4 is a schematic diagram illustrating an example combined model configured to jointly optimize a context model along with a hyperprior and the autoencoder. The following table illustrates meaning of different symbols.

TABLE
Illustration of symbols

| Component | Symbol |
|---|---|
| Input Image | x |
| Encoder | f(x; θₑ) |
| Latents | y |
| Latents (quantized) | ŷ |
| Decoder | g(ŷ; θ_{d}) |
| Hyper Encoder | fₕ(y; θₕₑ) |
| Hyper-Latents | z |
| Hyper-Latents (quantized) | \hat{z} |
| Hyper Decoder | gₕ(\hat{z}; θ_{hd}) |
| Context Model | g_{cm}(y_{<i}; θ_{cm}) |
| Entropy Parameters | gₑₚ(·; θₑₚ) |
| Reconstruction | \hat{x} |

The combined model jointly optimizes an autoregressive component that estimates the probability distributions of latents from their causal context (Context Model) along with a hyperprior and the underlying autoencoder. Real-valued latent representations are quantized (Q) to create quantized latents (ŷ) and quantized hyper-latents (\hat{z}), which are compressed into a bitstream using an arithmetic encoder (AE) and decompressed by an arithmetic decoder (AD). The dashed region corresponds to the components that are executed by the receiver (e.g, a decoder) to recover an image from a compressed bitstream.

An example system utilizes a joint architecture where both a hyper prior model subnetwork (hyper encoder and hyper decoder) and a context model subnetwork are utilized. The hyper prior and the context model are combined to learn a probabilistic model over quantized latents ŷ, which is then used for entropy coding. As depicted in FIG. 4, the outputs of the context subnetwork and hyper decoder subnetwork are combined by the subnetwork called Entropy Parameters, which generates the mean μ and scale (or variance) σ parameters for a Gaussian probability model. The gaussian probability model is then used to encode the samples of the quantized latents into bitstream with the help of the arithmetic encoder (AE) module. In the decoder the gaussian probability model is utilized to obtain the quantized latents y from the bitstream by arithmetic decoder (AD) module.

In an example, the latent samples are modeled as gaussian distribution or gaussian mixture models (not limited to). In the example according to FIG. 4, the context model and hyper prior are jointly used to estimate the probability distribution of the latent samples. Since a gaussian distribution can be defined by a mean and a variance (aka sigma or scale), the joint model is used to estimate the mean and variance (denoted as μ and σ).

### 2.3.5 Gained Variational Autoencoders (G-VAE)

In an example, neural network-based image/video compression methodologies need to train multiple models to adapt to different rates. Gained variational autoencoders (G-VAE) is the variational autoencoder with a pair of gain units, which is designed to achieve continuously variable rate adaptation using a single model. It comprises of a pair of gain units, which are typically inserted to the output of encoder and input of decoder. The output of the encoder is defined as the latent representation y∈R^{c*h*w}, where c, h, w represent the number of channels, the height and width of the latent representation. Each channel of the latent representation is denoted as y₍ᵢ₎∈R^{h*W}, where i=0, 1, . . . , c−1. A pair of gain units include a gain matrix M∈R^{c*n} and an inverse gain matrix, where n is the number of gain vectors. The gain vector can be denoted as mₛ={αₛ₍₀₎, αₛ₍₁₎, . . . , α_{s(c-1)}}, αₛ(i)∈R where s denotes the index of the gain vectors in the gain matrix.

The motivation of gain matrix is similar to the quantization table in JPEG by controlling the quantization loss based on the characteristics of different channels. To apply the gain matrix to the latent representation, each channel is multiplied with the corresponding value in a gain vector.

$${\overline{y}}_{s} = y ⊙ {m}_{s}$$

where ⊙ is channel-wise multiplication, i.e., y̅ₛ₍ᵢ₎=y₍ᵢ₎×αₛ₍ᵢ₎, and αₛ₍ᵢ₎ is the i-th gain value in the gain vector mₛ. The inverse gain matrix used at the decoder side can be denoted as M′∈R^{c*n}, which includes n inverse gain vectors, i.e., M′={δₛ₍₀₎, δₛ₍₁₎, . . . , δ_{s(c-1)}}, δₛ₍ᵢ₎∈R. The inverse gain process is expressed as:

$${y}_{s}^{′} = \hat{y} ⊙ {m}_{s}^{′}$$

where ŷ is the decoded quantized latent representation and

$${y}_{s}^{′}$$

is the inversely gained quantized latent representation, which will be fed into the synthesis network.

To achieve continuous variable rate adjustment, interpolation is used between vectors. Given two pairs of gain vectors

$$\{ {m}_{t} , {m}_{t}^{′} \} and \{ {m}_{r} , {m}_{r}^{′} \} ,$$

the interpolated gain vector can be obtained via the following equations:

$${m}_{v} = [ {( {m}_{r} )}^{l} \cdot {( {m}_{t} )}^{1 - l} ]$$

$${m}_{v}^{′} = [ {( {m}_{r}^{′} )}^{l} \cdot {( {m}_{t}^{′} )}^{1 - l} ]$$

where l∈R is an interpolation coefficient, which controls the corresponding bit rate of the generated gain vector pair. Since l is a real number, an arbitrary bit rate between the given two gain vector pairs can be achieved.

### 2.3.6 the Encoding Process Using Joint Auto-Regressive Hyper Prior Model

The design in FIG. 4. corresponds an example combined compression method. In this section and the next, the encoding and decoding processes are described separately.

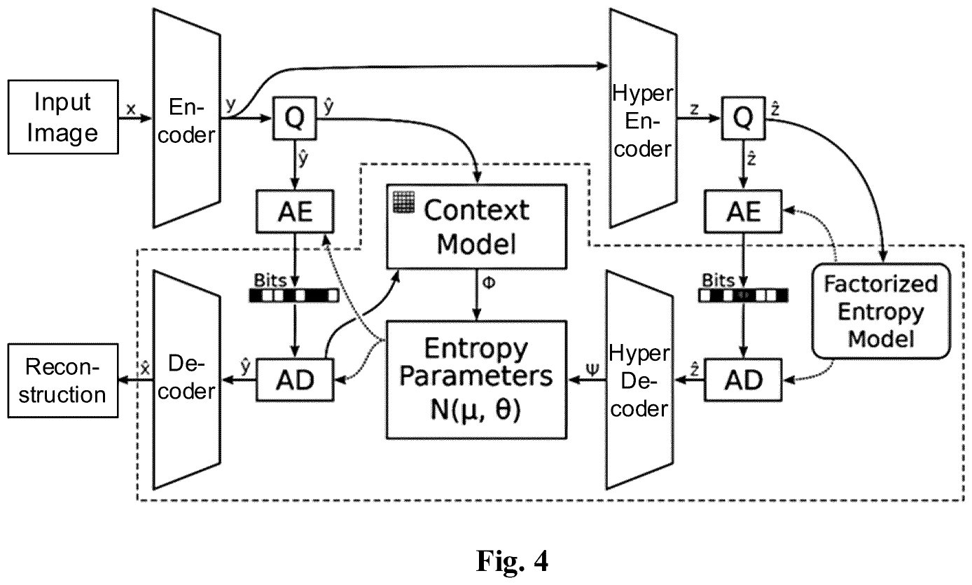

FIG. 5 illustrates an example encoding process. The input image is first processed with an encoder subnetwork. The encoder transforms the input image into a transformed representation called latent, denoted by y. y is then input to a quantizer block, denoted by Q, to obtain the quantized latent (ŷ). ŷ is then converted to a bitstream (bits1) using an arithmetic encoding module (denoted AE). The arithmetic encoding block converts each sample of the ŷ into a bitstream (bits1) one by one, in a sequential order.

The modules hyper encoder, context, hyper decoder, and entropy parameters subnetworks are used to estimate the probability distributions of the samples of the quantized latent ŷ. the latent y is input to hyper encoder, which outputs the hyper latent (denoted by z). The hyper latent is then quantized (\hat{z}) and a second bitstream (bits2) is generated using arithmetic encoding (AE) module. The factorized entropy module generates the probability distribution, that is used to encode the quantized hyper latent into bitstream. The quantized hyper latent includes information about the probability distribution of the quantized latent (ŷ).

The Entropy Parameters subnetwork generates the probability distribution estimations, that are used to encode the quantized latent ŷ. The information that is generated by the Entropy Parameters typically include a mean μ and scale (or variance) σ parameters, that are together used to obtain a gaussian probability distribution. A gaussian distribution of a random variable x is defined as

$$f ( x ) = \frac{1}{σ \sqrt{2 π}} {e}^{- \frac{1}{2} {( \frac{x - μ}{σ} )}^{2}}$$

wherein the parameter μ is the mean or expectation of the distribution (and also its median and mode), while the parameter σ is its standard deviation (or variance, or scale). In order to define a gaussian distribution, the mean and the variance need to be determined. The entropy parameters module is used to estimate the mean and the variance values.

The subnetwork hyper decoder generates part of the information that is used by the entropy parameters subnetwork, the other part of the information is generated by the autoregressive module called context module. The context module generates information about the probability distribution of a sample of the quantized latent, using the samples that are already encoded by the arithmetic encoding (AE) module. The quantized latent ŷ is typically a matrix composed of many samples. The samples can be indicated using indices, such as ŷ[i,j,k] or ŷ[i,j] depending on the dimensions of the matrix ŷ. The samples ŷ[i,j] are encoded by AE one by one, typically using a raster scan order. In a raster scan order the rows of a matrix are processed from top to bottom, wherein the samples in a row are processed from left to right. In such a scenario (wherein the raster scan order is used by the AE to encode the samples into bitstream), the context module generates the information pertaining to a sample ŷ[i,j], using the samples encoded before, in raster scan order. The information generated by the context module and the hyper decoder are combined by the entropy parameters module to generate the probability distributions that are used to encode the quantized latent ŷ into bitstream (bits1).

Finally, the first and the second bitstream are transmitted to the decoder as result of the encoding process. It is noted that the other names can be used for the modules described above.

In the above description, all of the elements in FIG. 5 are collectively called an encoder. The analysis transform that converts the input image into latent representation is also called an encoder (or auto-encoder).

### 2.3.7 The Decoding Process Using Joint Auto-Regressive Hyper Prior Model

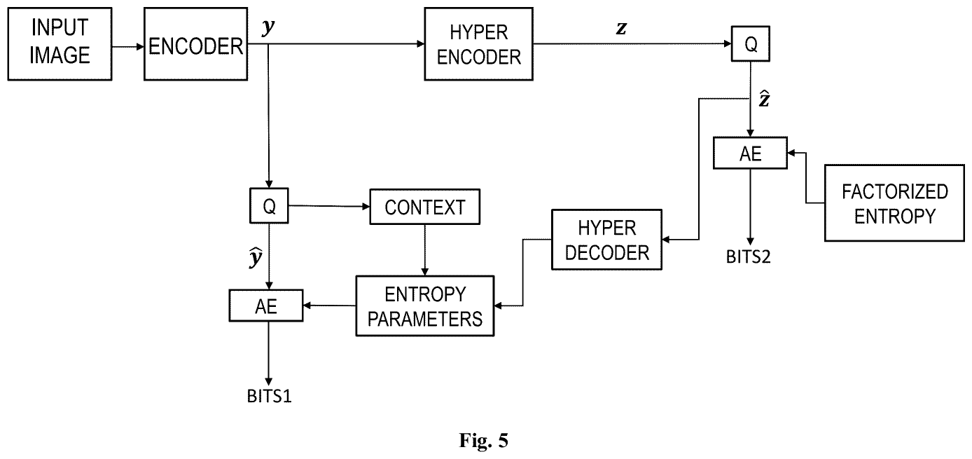

FIG. 6 illustrates an example decoding process. FIG. 6 depicts a decoding process separately.

In the decoding process, the decoder first receives the first bitstream (bits1) and the second bitstream (bits2) that are generated by a corresponding encoder. The bits2 is first decoded by the arithmetic decoding (AD) module by utilizing the probability distributions generated by the factorized entropy subnetwork. The factorized entropy module typically generates the probability distributions using a predetermined template, for example using predetermined mean and variance values in the case of gaussian distribution. The output of the arithmetic decoding process of the bits2 is \hat{z}, which is the quantized hyper latent. The AD process reverts to AE process that was applied in the encoder. The processes of AE and AD are lossless, meaning that the quantized hyper latent \hat{z} that was generated by the encoder can be reconstructed at the decoder without any change.

After obtaining of \hat{z}, it is processed by the hyper decoder, whose output is fed to entropy parameters module. The three subnetworks, context, hyper decoder and entropy parameters that are employed in the decoder are identical to the ones in the encoder. Therefore, the exact same probability distributions can be obtained in the decoder (as in encoder), which is essential for reconstructing the quantized latent y without any loss. As a result, the identical version of the quantized latent y that was obtained in the encoder can be obtained in the decoder.

After the probability distributions (e.g. the mean and variance parameters) are obtained by the entropy parameters subnetwork, the arithmetic decoding module decodes the samples of the quantized latent one by one from the bitstream bits1. From a practical standpoint, autoregressive model (the context model) is inherently serial, and therefore cannot be sped up using techniques such as parallelization. Finally, the fully reconstructed quantized latent ŷ is input to the synthesis transform (denoted as decoder in FIG. 6) module to obtain the reconstructed image.

In the above description, the all of the elements in FIG. 6 are collectively called decoder. The synthesis transform that converts the quantized latent into reconstructed image is also called a decoder (or auto-decoder).

### 2.4 Neural Networks for Video Compression

Similar to video coding technologies, neural image compression serves as the foundation of intra compression in neural network-based video compression. Thus, development of neural network-based video compression technology is behind development of neural network-based image compression because neural network-based video compression technology is of greater complexity and hence needs far more effort to solve the corresponding challenges. Compared with image compression, video compression needs efficient methods to remove inter-picture redundancy. Inter-picture prediction is then a major step in these example systems. Motion estimation and compensation is widely adopted in video codecs, but is not generally implemented by trained neural networks.

Neural network-based video compression can be divided into two categories according to the targeted scenarios: random access and the low-latency. In random access case, the system allows decoding to be started from any point of the sequence, typically divides the entire sequence into multiple individual segments, and allows each segment to be decoded independently. In a low-latency case, the system aims to reduce decoding time, and thereby temporally previous frames can be used as reference frames to decode subsequent frames.

### 2.5 Preliminaries

Almost all the natural image and/or video is in digital format. A grayscale digital image can be represented by x∈ [symbol] ^{m×n}, where [symbol] is the set of values of a pixel, m is the image height, and n is the image width. For example, [symbol] ={0, 1, 2, . . . , 255} is an example setting, and in this case | [symbol] |=256=2⁸. Thus, the pixel can be represented by an 8-bit integer. An uncompressed grayscale digital image has 8 bits-per-pixel (bpp), while compressed bits are definitely less.

A color image is typically represented in multiple channels to record the color information. For example, in the RGB color space an image can be denoted by x∈ [symbol] ^{m×n×3} with three separate channels storing Red, Green, and Blue information. Similar to the 8-bit grayscale image, an uncompressed 8-bit RGB image has 24 bpp. Digital images/videos can be represented in different color spaces. The neural network-based video compression schemes are mostly developed in RGB color space while the video codecs typically use a YUV color space to represent the video sequences. In YUV color space, an image is decomposed into three channels, namely luma (Y), blue difference chroma (Cb) and red difference chroma (Cr). Y is the luminance component and Cb and Cr are the chroma components. The compression benefit to YUV occur because Cb and Cr are typically down sampled to achieve pre-compression since human vision system is less sensitive to chroma components.

A color video sequence is composed of multiple color images, also called frames, to record scenes at different timestamps. For example, in the RGB color space, a color video can be denoted by X={x₀, x₁, . . . , xₜ, . . . , x_{T-1}} where T is the number of frames in a video sequence and x∈ [symbol] _{m×n}. If m=1080, n=1920, | [symbol] |=2⁸, and the video has 50 frames-per-second (fps), then the data rate of this uncompressed video is 1920×1080×8×3×50=2,488,320,000 bits-per-second (bps). This results in about 2.32 gigabits per second (Gbps), which uses a lot storage and should be compressed before transmission over the internet.

Usually the lossless methods can achieve a compression ratio of about 1.5 to 3 for natural images, which is clearly below streaming requirements. Therefore, lossy compression is employed to achieve a better compression ratio, but at the cost of incurred distortion. The distortion can be measured by calculating the average squared difference between the original image and the reconstructed image, for example based on MSE. For a grayscale image, MSE can be calculated with the following equation.

$$MSE = \frac{{‖ x - \hat{x} ‖}^{2}}{m \times n} \qquad ( 4 )$$

Accordingly, the quality of the reconstructed image compared with the original image can be measured by peak signal-to-noise ratio (PSNR):

$$PSNR = 10 \times {log}_{10} \frac{{( max ( 𝔻 ) )}^{2}}{MSE} \qquad ( 5 )$$

where max( [symbol] ) is the maximal value in [symbol] , e.g., 255 for 8-bit grayscale images. There are other quality evaluation metrics such as structural similarity (SSIM) and multi-scale SSIM (MS-SSIM).

To compare different lossless compression schemes, the compression ratio given the resulting rate, or vice versa, can be compared. However, to compare different lossy compression methods, the comparison has to take into account both the rate and reconstructed quality. For example, this can be accomplished by calculating the relative rates at several different quality levels and then averaging the rates. The average relative rate is known as Bjontegaard's delta-rate (BD-rate). There are other aspects to evaluate image and/or video coding schemes, including encoding/decoding complexity, scalability, robustness, and so on.

### 2.6 Separate Processing of Luma and Chroma Components of an Image

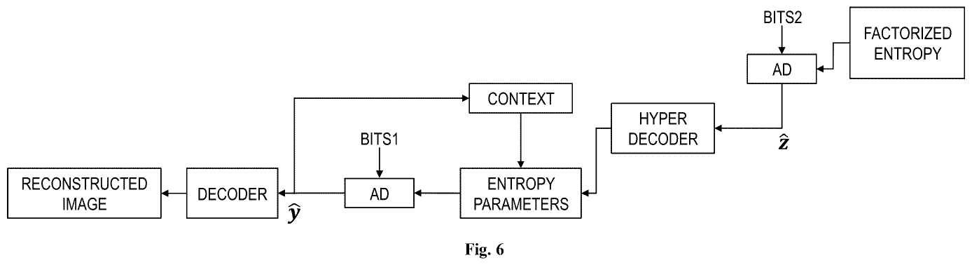

FIG. 7 illustrates an example decoding process according to the present disclosure.

According to one implementation, the luma and chroma components of an image can be decoded using separate subnetworks. In FIG. 7, the luma component of the image is processed by the subnetworks “Synthesis”, “Prediction fusion”, “Mask Conv”, “Hyper Decoder”, “Hyper scale decoder” etc. Whereas the chroma components are processed by the subnetworks: “Synthesis UV”, “Prediction fusion UV”, “Mask Conv UV”, “Hyper Decoder UV”, “Hyper scale decoder UV” etc.

A benefit of this separate processing is that the computational complexity of the processing of an image is reduced by application of separate processing. Typically, in neural network-based image and video decoding, the computational complexity is proportional to the square of the number of feature maps. For example, if the number of total feature maps is 192, computational complexity will be proportional to 192×192. On the other hand, if the feature maps are divided into 128 for luma and 64 for chroma (in the case of separate processing), the computational complexity is proportional to 128×128+64×64, which corresponds to a reduction in complexity by 45%. Typically, the separate processing of luma and chroma components of an image does not result in a prohibitive reduction in performance, as the correlation between the luma and chroma components are typically very small.

The processing (Decoding process) in FIG. 7 can be explained below:
1. Firstly, the factorized entropy model is used to decode the quantized latents for luma and chroma, i.e., \hat{z} and \hat{z}ᵤᵥ in FIG. 7.
2. The probability parameters (e.g., variance) generated by the second network are used to generate a quantized residual latent by performing the arithmetic decoding process.
3. The quantized residual latent is inversely gained with the inverse gain unit (iGain) as shown in orange color in FIG. 7. The outputs of the inverse gain units are denoted as ŵ and ŵ_{UV} for luma and chroma components, respectively.
4. For the luma component, the following steps are performed in a loop until all elements of ŷ are obtained:
   a. A first subnetwork is used to estimate a mean value parameter of a quantized latent (ŷ), using the already obtained samples of ŷ.
   b. The quantized residual latent w and the mean value are used to obtain the next element of ŷ.
5. After all the samples of ŷ are obtained, a synthesis transform can be applied to obtain the reconstructed image.
6. For chroma component, steps 4 and 5 are the same but with a separate set of networks.
7. The decoded luma component is used as additional information to obtain the chroma component. Specifically, the Inter Channel Correlation Information filter sub-network (ICCI) is used for chroma component restoration. The luma is fed into the ICCI sub-network as additional information to assist the chroma component decoding.
8. Adaptive color transform (ACT) is performed after the luma and chroma components are reconstructed.

The module named ICCI is a neural-network based postprocessing module. The examples are not limited to the UCCI subnetwork. Any other neural network based postprocessing module might also be used.

An exemplary implementation of the disclosure is depicted in FIG. 7 (the decoding process). The framework comprises two branches for luma and chroma components respectively. In each of the branches, the first subnetwork comprises the context, prediction and optionally the hyper decoder modules. The second network comprises the hyper scale decoder module. The quantized hyper latent are \hat{z} and \hat{z}ᵤᵥ. The arithmetic decoding process generates the quantized residual latents, which are further fed into the iGain units to obtain the gained quantized residual latents ŵ and ŵᵤᵥ.

After the residual latent is obtained, a recursive prediction operation is performed to obtain the latent ŷ and ŷᵤᵥ. The following steps describe how to obtain the samples of latent ŷ[:, i, j], and the chroma component is processed in the same way but with different networks.
1. An autoregressive context module is used to generate first input of a prediction module using the samples ŷ[:, m, n] where the (m, n) pair are the indices of the samples of the latent that are already obtained.
2. Optionally the second input of the prediction module is obtained by using a hyper decoder and a quantized hyper latent [symbol] .
3. Using the first input and the second input, the prediction module generates the mean value mean[:, i, j].
4. The mean value mean[:, i, j] and the quantized residual latent ŵ[:, i, j] are added together to obtain the latent ŷ [:, i, j].
5. The steps 1-4 are repeated for the next sample.

Whether to and/or how to apply at least one method disclosed in the document may be signaled from the encoder to the decoder, e.g., in the bitstream.

Whether to and/or how to apply at least one method disclosed in the document may be determined by the decoder based on coding information, such as dimensions, color format, etc.

Further, the modules named MS1, MS2 or MS3+O (in FIG. 7), might be included in the processing flow. The said modules might perform an operation to their input by multiplying the input with a scalar or adding an adding an additive component to the input to obtain the output. The scalar or the additive component that are used by the said modules might be indicated in a bitstream.

The module named RD or the module named AD in FIG. 7 might be an entropy decoding module. It might be a range decoder or an arithmetic decoder or the like.

The examples described herein is not limited to the specific combination of the units exemplified in FIG. 7. Some of the modules might be missing and some of the modules might be displaced in processing order. In addition, additional modules might be included. For example:
1. The ICCI module might be removed. In that case the output of the Synthesis module and the Synthesis UV module might be combined by means of another module, that might be based on neural networks.
2. One or more of the modules named MS1, MS2 or MS3+O might be removed. The core of the disclosure is not affected by the removing of one or more of the said scaling and adding modules.

In FIG. 7, other operations that are performed during the processing of the luma and chroma components are also indicated using the star symbol. These processes are denoted as MS1, MS2, MS3+O. These processing might be, but not limited to, adaptive quantization, latent sample scaling, and latent sample offsetting operations. For example, in an adaptive quantization process might correspond to scaling of a sample with multiplier before the prediction process, wherein the multiplier is predefined or whose value is indicated in the bitstream. The latent scaling process might correspond to the process where a sample is scaled with a multiplier after the prediction process, wherein the value of the multiplier is either predefined or indicated in the bitstream. The offsetting operation might correspond to adding an additive element to the sample, again wherein the value of the additive element might be indicated in the bitstream or inferred or predetermined.

Another operation might be tiling operation, wherein samples are first tiled (grouped) into overlapping or non-overlapping regions, wherein each region is processed independently. For example, the samples corresponding to the luma component might be divided into tiles with a tile height of 20 samples, whereas the chroma components might be divided into tiles with a tile height of 10 samples for processing.

Another operation might be application of wavefront parallel processing. In wavefront parallel processing, a number of samples might be processed in parallel, and the amount of samples that can be processed in parallel might be indicated by a control parameter. The said control parameter might be indicated in the bitstream, be inferred, or can be predetermined. In the case of separate luma and chroma processing, the number of samples that can be processed in parallel might be different, hence different indicators can be signalled in the bitstream to control the operation of luma and chrome processing separately.

### 2.7 Colors Separation and Conditional Coding

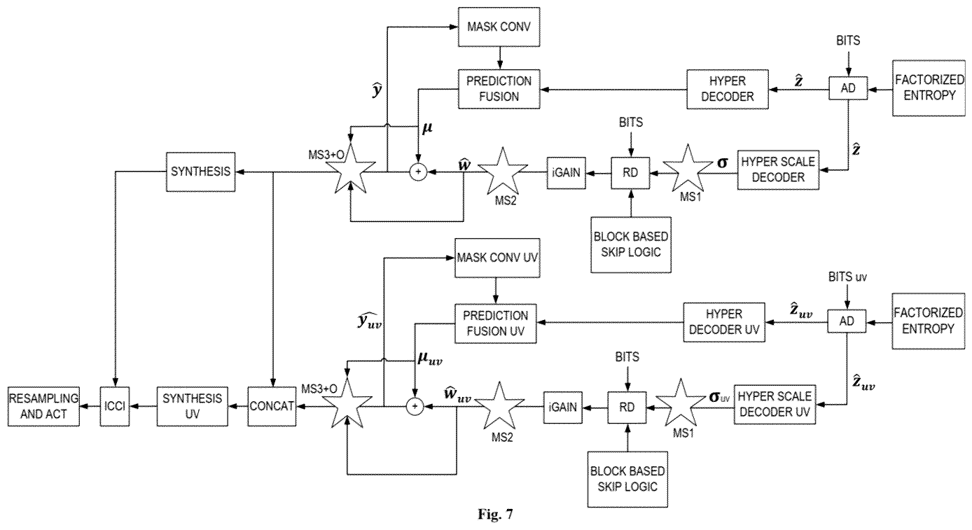

FIG. 8 illustrates an example learning-based image codec architecture.

In one example the primary and secondary color components of an image are coded separately, using networks with similar architecture, but different number of channels as shown in FIG. 8. All boxes with same names are sub-networks with the similar architecture, only input-output tensor size and number of channels are different. Number of channels for primary component is Cₚ=128, for secondary components is Cₛ=64. The vertical arrows (with arrowhead pointing downwards) indicate data flow related to secondary color components coding. Vertical arrows show data exchange between primary and secondary components pipelines.

The input signal to be encoded is notated as x, latent space tensor in bottleneck of variational auto-encoder is y. Subscript “Y” indicates primary component, subscript “UV” is used for concatenated secondary components, there are chroma components.

First the input image that has RGB color format is converted to primary (Y) and secondary components (UV). The primary component x_{Y} is coded independently from secondary components x_{UV} and the coded picture size is equal to input/decoded picture size. The secondary components are coded conditionally, using x_{Y} as auxiliary information from primary component for encoding x_{UV} and using ŷ_{Y} as a latent tensor with auxiliary information from primary component for decoding ŷ_{UV} reconstruction. The codec structure for primary component and secondary components are almost identical except the number of channels, size of the channels and the several entropy models for transforming latent tensor to bitstream, therefore primary and secondary latent tensor will generate two different bitstream based on two different entropy models. Prior to the encoding x_{Y}, x_{UV} goes through a module which adjusts the sample location by down-sampling (marked as “s↓” on FIG. 8), this essentially means that coded picture size for secondary component is different from the coded picture size for primary component. The scaling factor s is variable, but the default scaling factor is s=2. The size of auxiliary input tensor in conditional coding is adjusted in order the encoder receives primary and secondary components tensor with the same picture size. After reconstruction, the secondary component is rescaled to the original picture size with a neural-network based upsampling filter module (“NN-color filter s1” on FIG. 8), which outputs secondary components up-sampled with factor s.

The example in FIG. 8 exemplifies an image coding system, where the input image is first transformed into primary (Y) and secondary components (UV). The outputs \hat{x}_{Y}, \hat{x}_{UV} are the reconstructed outputs corresponding to the primary and secondary components. At the and of the processing, \hat{x}_{Y}, x_{UV} are converted back to RGB color format. Typically, the x_{UV} is downsampled (resized) before processing with the encoding and decoding modules (neural networks). For example, the size of the x_{UV} might be reduced by a factor of 50% in each of the vertical and horizontal dimensions. Therefore, the processing of the secondary component includes approximately 50%×50%=25% less samples, therefore it is computationally less complex.

### 2.8 Cropping Operation in Neural Network Based Coding

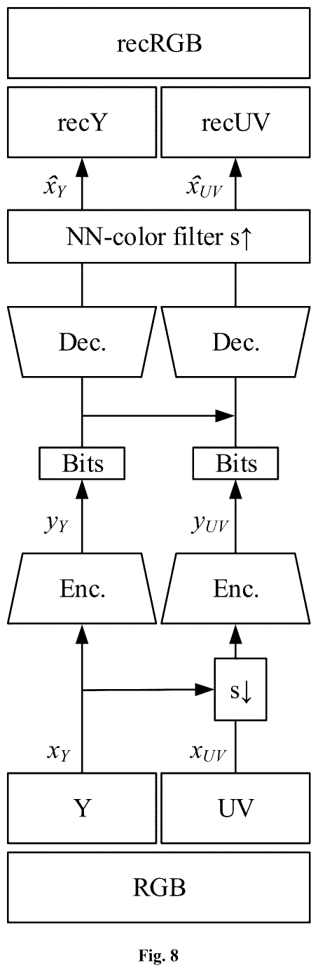

FIG. 9 illustrates an example synthesis transform for learning based image coding.

The example synthesis transform above includes a sequence of 4 convolutions with up-sampling with stride of 2. The synthesis transform sub-Net is depicted on FIG. 9. The size of the tensor in different parts of synthesis transform before cropping layer is the diagram on FIG. 9.

The cropping layer changes tensor size h_{d}×w_{d} to h_{d-1}×w_{d-1}, where h_{d}=2·ceil(H/2^{d}); w_{d}=2·ceil W/2^{d}); here d is the depth of proceeding convolution in the codec architecture. For primary component Synthesis Transform receives input tensor with size of h×w, where h=ceil(H/16); w=ceil(W/16). The output of Synthesis Transform for primary component is 1×h₀×w₀, where h₀=H; h₀=W.

For secondary component Synthesis Transform receives input tensor with size h_{UV}×w_{UV}; h_{UV}=ceil(ceil(H/s)/16); w_{UV}=ceil(ceil(W/s)/16). The output of the Synthesis Transform for primary component is 2×h_{UV0}×w_{UV0}, where h_{UV0}=ceil(H/s); h_{UV0}=ceil(W/s). For secondary components input sizes are h₀=ceil(H/s); w₀=ceil(W/s), where s is the scale factor. The scale factor might be 2 for example, wherein the secondary component is downsampled by a factor of 2.

Based on the above explanation, the operation of the cropping layers depend on the output size H, W and the depth of the cropping layer. The depth of the left-most cropping layer in FIG. 9 is equal to 0. The output of this cropping layer must be equal to H, W (the output size), if the size of the input of this cropping layer is greater than H or W in horizontal or vertical dimension respectively, cropping needs to be performed in that dimension. The second cropping layer counting from left to right has a depth of 1. The output of the second cropping layer must be equal to h₁=2·ceil(H/2¹); w₁=2·ceil(W/2¹), which means if the input of this second cropping layer is greater than h1, w1 in any dimension, than cropping is applied in that dimension. In summary, the operation of cropping layers are controlled by the output size H, W. In one example if H and W are both equal to 16, then the cropping layers do not perform any cropping. On the other hand, if H and W are both equal to 17, then all 4 cropping layers are going to perform cropping.

### 2.9 Bitwise Shifting

The bitwise shift operator can be represented using the function bitshift(x, n), where n is an integer number. If n is greater than 0, it corresponds to right-shift operator (>>), which moves the bits of of the input to the right, and the left-shift operator (<<), which moves the bits to the left. In other words the bitshift(x, n) operation corresponds to:

$$bitshift ( x , n ) = x * {2}^{n} , or$$

$$bitshift ( x , n ) = floor ( x * {2}^{n} ) , or$$

$$bitshift ( x , n ) = x / / {2}^{n} .$$

The output of the bitshift operation is an integer value. In some implementations, the floor( ) function might be added to the definition.

floor(x) is equal to the largest integer less than or equal to x.

The “//” operator or the integer division operator. It is an operation that comprises division and truncation of the result toward zero. For example, 7/4 and −7/−4 are truncated to 1 and −7/4 and 7/−4 are truncated to −1.

$$rightshift ( x , n ) = x ≫ n \\ or \\ leftshift ( x , n ) = x ≪ n$$

Equation 3: alternative implementation of the bitshift operator as rightshift or leftshift.
x>>y Arithmetic right shift of a two's complement integer representation of x by y binary digits. This function is defined only for non-negative integer values of y. Bits shifted into the most significant bits (MSBs) as a result of the right shift have a value equal to the MSB of x prior to the shift operation.
X<<y Arithmetic left shift of a two's complement integer representation of x by y binary digits. This function is defined only for non-negative integer values of y. Bits shifted into the least significant bits (LSBs) as a result of the left shift have a value equal to 0.

### 2.10 Convolution Operation

The convolution operation starts with a kernel, which is a small matrix of weights. This kernel “slides” over the input data, performing an elementwise multiplication with the part of the input it is currently on, and then summing up the results into a single output pixel. In some cases, the convolution operation might comprise a “bias”, which is added to the output of the elementwise multiplication operation.

The convolution operation may be described by the following mathematical formula. An output out1 can be obtained as:

$$out 1 [ x , y ] = conv 1 ( I ) = {\sum }_{k = 0}^{M} {\sum }_{i = 0}^{N} {\sum }_{j = 0}^{P} w {1}_{k} [ i , j ] \times {I}_{k} [ x + i , y + j ] + K 1$$

where w1 are the multiplication factors, K1 is called a bias (an additive term), Iₖ is the kth input, N is the kernel size in one direction and P is the kernel size in another direction. The convolution layer might comprise convolution operations wherein more than one output might be generated. Other equivalent depictions of the convolution operation might be found below:

$$out 1 [ x , y ] = conv 1 ( I ) = {\sum }_{k = 0}^{M} {\sum }_{i = 0}^{N} {\sum }_{j = 0}^{P} w 1 [ k , i , j ] \times I [ k , x + i , y + j ] + K 1 \\ out [ c , x , y ] = c o nv ( I ) = {\sum }_{k = 0}^{M} {\sum }_{i = 0}^{N} {\sum }_{j = 0}^{P} w [ c , k , i , j ] \times I [ k , x + i , y + j ] + K [ c ]$$

In the above equations “c” indicates the channel number. It is equivalent to output number, out [1,x,y] is one output and out [2,x,y] is a second output. The k is the input number, I[1, x, y] is one input, and I[2, x, y] is a second input. The w1, or w describe weights of the convolution operation.

### 2.11 LeakyReLU Activation Function

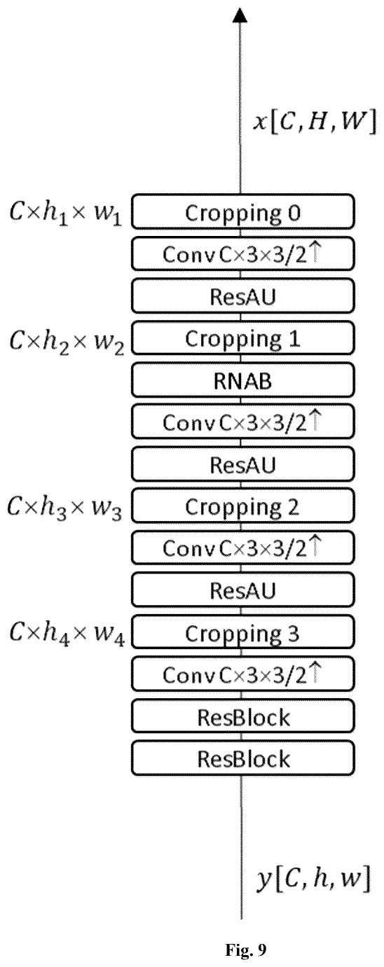

FIG. 10 illustrates an example LeakyReLU activation function. The LeakyReLU activation function is depicted in FIG. 10. According to the function, if the input is a positive value, the output is equal to the input. If the input (y) is a negative value, the output is equal to a*y. The a is typically (not limited to) a value that is smaller than 1 and greater than 0. Since the multiplier a is smaller than 1, it can be implemented either as a multiplication with a non-integer number, or with a division operation. The multiplier a might be called the negative slope of the LeakyReLU function.

### 2.12 ReLU Activation Function

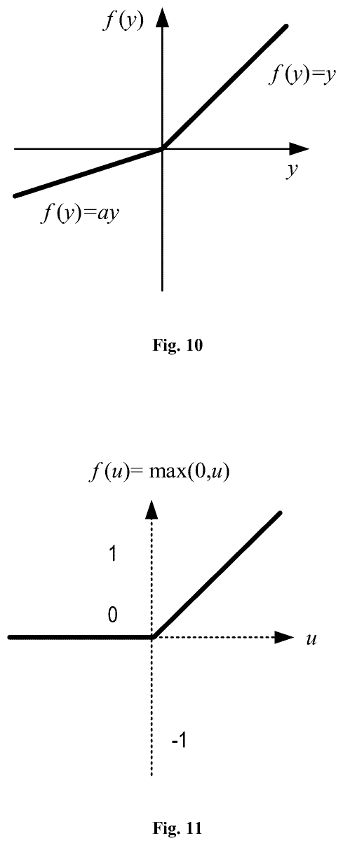

FIG. 11 illustrates an example ReLU activation function. The ReLU activation function is depicted in FIG. 11. According to the function, if the input is a positive value, the output is equal to the input. If the input (y) is a non-positive value, the output is equal to 0.

### 3. Technical Problems Solved by Disclosed Technical Solutions

When the components of the image, e.g., a luma component and a chroma component, are processed with different synthesis subnetworks, the correlations between the different components are not fully utilized. In other words, information that might be important for reconstruction of one component might also be relevant for the reconstruction of a second component too. This joint information cannot be fully utilized when 2 different synthesis transforms are utilized to reconstruct 2 different components.

### 4. A Listing of Solutions and Embodiments

### 4.1 Central Examples

The disclosure has the goal of improving the quality of a component of an image, using the information from another component. This goal is achieved by:
Using common processing layers that are used in neural network implementations.
And by including the weight and offset (bias) parameters of the said processing layers in the bitstream.

### Decoder Operation:

According to some examples, a bitstream is converted to a reconstructed image using a neural network, comprising the following operations:
Obtaining a weight value from the bitstream.
Obtaining an offset value.
Obtaining a resulting value according to the any or all of the following:
   Applying the offset value to a sample of the first component.
   Applying a thresholding function (e.g. a Relu operation) to the sample of the first component.
   Applying the weight value to the sample of the first component.
Obtaining a sample of the modified second component according to the resulting value and a sample of the second component.
Obtaining the reconstructed image using the sample of the first component and sample of the modified second component.

### Encoder Operation:

According to some examples, an image is converted to a bitstream using a neural network, comprising the following operations:
Obtaining/determining an offset value.
Obtaining a resulting value according to the any or all of the following:
   Applying the offset value to a sample of the first component.
   Applying a thresholding function (e.g. a Relu operation) to the sample of the first component.
   Calculating a weight value.
Obtaining a sample of the modified second component according to the resulting value and a sample of the second component.
Obtaining the reconstructed image using the sample of the first component and sample of the modified second component, wherein the weight value is calculated (selected) in order to maximize the quality of the reconstructed image.
Including the weight value in a bitstream.
   The first component, or second component, or any component mentioned above might be a component of an image.
It might be a chroma component, or a luma component.
A mean value might be subtracted from any of the components before the application of some embodiments of the present disclosure.
After the application of some embodiments of the present disclosure, a mean value might be added to the upsampled component.
   In one example, the first component is the Y in YCbCr color format, and the second component is the Cb or Cr component.
   In one example, the first component is the G component in RGB color format and the second component is the B/R component.
   In one example, two offsets and/or two weights may be signalled in the bitstream.
Alternatively, only one offset and/or one weight may be signalled in the bitstream, and the second/third component may share the same values.
Alternatively, predictive coding may be applied to code one of the two weights.
Alternatively, predictive coding may be applied to code one of the two offsets.

### 4.2 Details of the Examples

Five example implementations of the disclosure can be according to the following equations:

$$recU [ 1 , x , y ] = r e c U [ 1 , x , y ] + {\sum }_{n = 0}^{M} RELU ( W [ n ] * r e c Y ( 1 , x , y ) + b [ n ] ) \qquad ( 6 )$$

$$or$$

$$recU [ 1 , x , y ] = r e c U [ 1 , x , y ] + {\sum }_{n = 0}^{M} W [ n ] * R E L U ( r e c Y ( 1 , x , y ) + b [ n ] ) \qquad ( 7 )$$

$$or$$

$$recU [ 1 , x , y ] = K + W [ M + 1 ] * r e c U [ 1 , x , y ] + {\sum }_{n = 0}^{M} RELU ( W [ n ] * r e c Y ( 1 , x , y ) + b [ n ] \qquad ( 8 )$$

$$or$$

$$recU [ 1 , x , y ] = K + W [ M + 1 ] * r e c U [ 1 , x , y ] + {\sum }_{n = 0}^{M} W [ n ] * RELU ( recY ( 1 , x , y ) + b [ n ] \qquad ( 9 )$$

$$or$$

$$recU [ 1 , x , y ] = K + W [ M + 1 ] * r e c U [ 1 , x , y ] + {\sum }_{n = 0}^{M} W [ n ] * R E L U ( {W}_{2} [ n ] * r e c Y ( 1 , x , y ) + b [ n ] ) \qquad ( 10 )$$

In the equations above the first component is rec Y (e.g. a luma component of an image).
The second component is recU (e.g. a chroma component of an image).
The thresholding function is RELU( ) function.
The weight is W[n]. In the equation above M different weight values are used.
The offset is b[n]. In the example equation, M different offset values are used.)
The index [1,x,y] indicates a sample at the coordinates [1, x, y], which is the coordinate of a sample of the first component or second component.
According to equation (6), the multiplicative weight value W[n] is first applied to the samples of the first component. Then the additive offset value b[n] is applied the samples. Afterwards the thresholding function (RELU in the example) is applied. In the example up to M such weight and offset values are applied to the first sample and the result is added together using the summation operation

$$( {\sum }_{n = 0}^{M} ) .$$

Finally, the result of the summation operation is added to the sample of the second component. The equation (8) is similar to the equation (6).
According to the equation (7), the additive offset value b[n] is first applied the samples. Afterwards the thresholding function (RELU in the example) is applied. Then the multiplicative weight value (W[n]) is applied. In the example, up to M such weight and offset values are applied to the first sample and the result is added together using the summation operation

$$( {\sum }_{n = 0}^{M} ) .$$

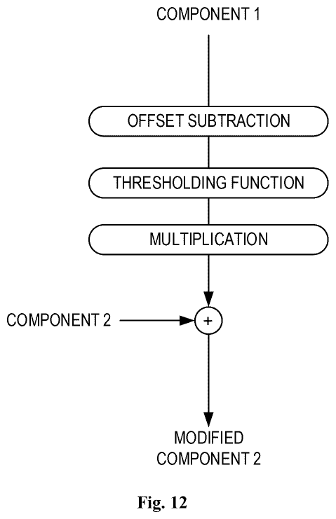

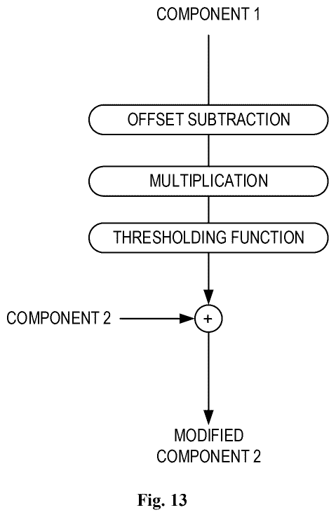

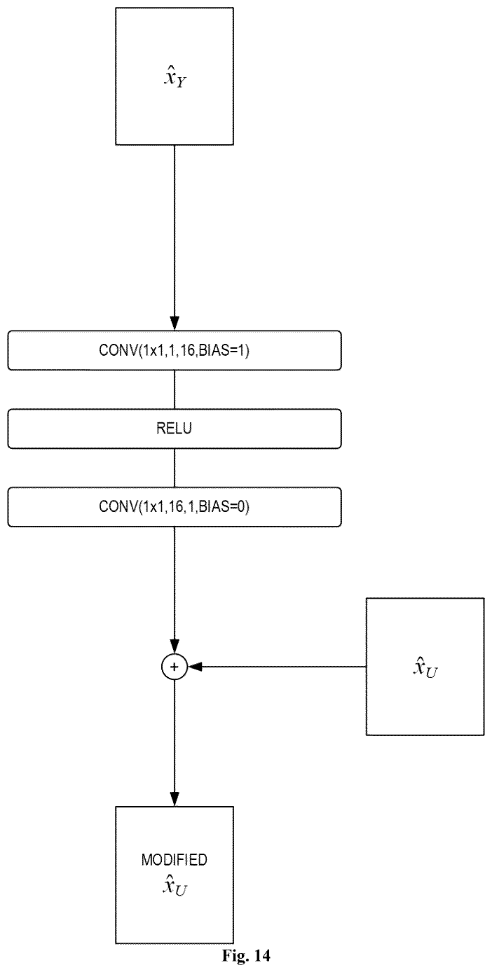

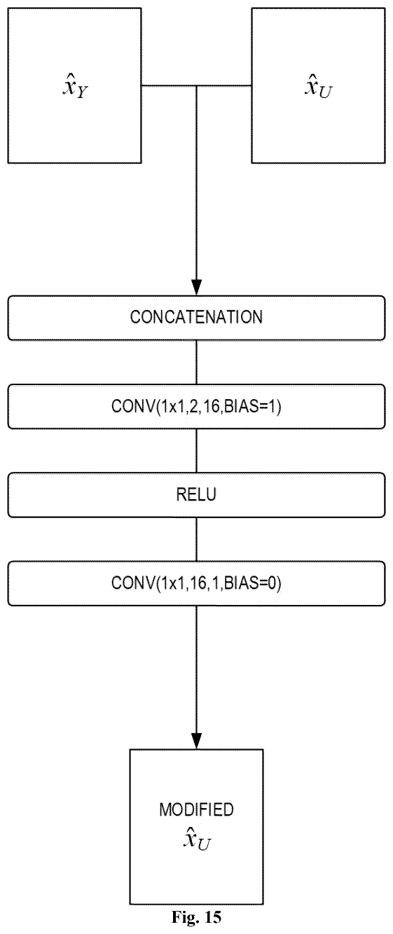

Finally, the result of the summation operation is added to the sample of the second component. The equation (9) is similar to the equation (6).
A mean value might be subtracted from recU or recY before inputting to the process. The mean value might be the mean value (average value) of the samples of recU or recY.
A mean value might be added to modified recU. The mean value might be the mean value (average value) of the samples of recU or recY.
FIG. 12 is a flowchart for an example method of video processing. FIG. 13 is a flowchart for an example method of video processing. Flowcharts in FIG. 12 and FIG. 13 depict example implementations of the disclosure.
   Firstly, an offset subtraction (or addition) is performed on component 1. Then, in FIG. 12, a thresholding function is performed. Finally, a weight is applied, and the output is added to the second component. At the end of the flowchart, the modified second component is obtained. The reconstructed image at the end of decoder or encoder is obtained according to the first component and the modified second component.
   In FIG. 13, operation is very similar to FIG. 12, except for the fact that the order of the multiplication with weight and thresholding operations are swapped.
   A mean value might be subtracted from the inputs before application of some embodiments of the present disclosure. The mean value might be the mean value (average value) of the samples of a first component of second component.
   A mean value might be added to the output of the method. The mean value might be the mean value (average value) of the samples of a first component of second component.
The thresholding function might be (not limited to) a RELU operation, a leaky Relu operation, a sigmoid operation, a hyperbolic tangent operation, or a MAX(x,y) operation or a MIN(x,y) operation. The MAX(x,y) operation outputs the maximum of two values, x or y. and MIN(x,y) outputs the minimum of two values, x or y.
   Sigmoid function might be described as: ƒ(x)=1/(1+e^{-x}).
   Hyperbolic tangent might be described as: ƒ(x)=tanh(x)=2/(1+e^{-2x})−1).
   In MAX(x,y) operation or in MIN(x,y) operation, one of the input values might be zero. In other words, the thresholding function might be MAX (x, 0) or MIN (x, 0).
The weight value might be implemented as part of a convolution function.
The offset value might be implemented as part of a convolution function. More specifically the offset value might be implemented as the bias value of a convolution function.
The first component might be a luma or a luminance component of an image.
The second component might be a U-chroma component, or a V-chroma component, or a chroma component or a chrominance component.
FIG. 14 is a flowchart for an example method of video processing. Flowchart in FIG. 14 depicts another example implementation of the disclosure. In the example, the first component \hat{x}_{Y} is processed by a first convolution layer (e.g. Conv(1×1, 2, 16, bias=1) as in FIG. 14, an activation function (e.g. Relu in FIG. 14), and a second convolution layer (e.g. Conv(1×1, 16, 1, bias=0) as in FIG. 14). The convolution layer is capable of applying an offset (i.e. a bias) and a multiplicative value (weight value). Therefore, the multiplicative weight value and the additive offset value can be applied by means of a convolution layer. The example in FIG. 14 depicts the fact that the disclosure can be implemented using the most common neural network processing layers, namely the convolution layer and activation layer such as relu function.
FIG. 15 is a flowchart for an example method of video processing. Flowchart in FIG. 15 depicts another example implementation of the disclosure. This example is similar to FIG. 14, the difference being the fact that both the first component and the second component are input the first convolution layer (e.g. Conv(1×1, 2, 16, bias=1)), and the addition operation at the end is removed.
   In FIG. 15 the following equation might be implemented:

$$r e c U [ 1 , x , y ] = K + {W}_{3} * r e c U [ 1 , x , y ] + {\sum }_{n = 0}^{M} W [ n ] * R E L U ( {W}_{2} [ n ] * r e c Y ( 1 , x , y ) + b [ n ] )$$

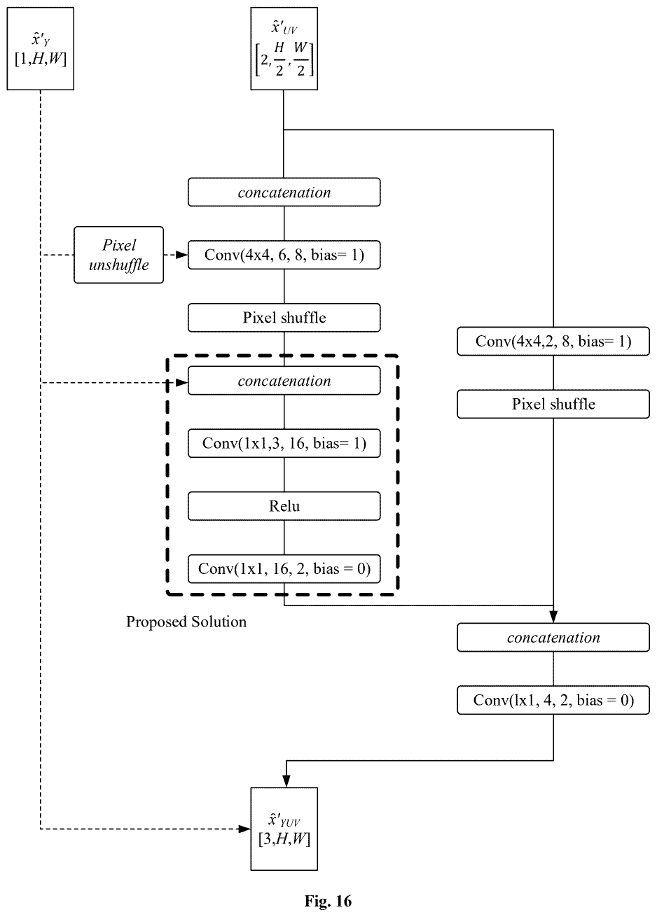

FIG. 16 illustrates an example neural network. The flowchart in FIG. 16 depicts implementation of the disclosure is inside a bigger network.
According to the disclosure the multiplicative weight values might be included in a bitstream at the encoder, or obtained from a bitstream at the decoder.
According to the disclosure the additive offset values (or bias values) might be obtained from a bitstream.
A mean value might be subtracted from recU or recY before inputting to the process. The mean value might be the mean value (average value) of the samples of recU or recY.
A mean value might be added to modified recU. The mean value might be the mean value (average value) of the samples of recU or rec Y.
The offset values might be obtained according to a maximum value and/or a minimum value.
   The maximum value might be the maximum value of the samples of the first component.
   The minimum value might be the minimum value of the samples of the first component.
   The maximum or the minimum value might be obtained from a bitstream.
   The offset value might be obtained according to a value N, that is used to divide the difference of the maximum and the minimum value.
      The N might be predefined or might be obtained from a bitstream.
   The offset values 1 . . . . N might be obtained as follows:

$$Offset [ n ] = \frac{maximum\_value - minimum\_value}{N} * n + minimum\_value ,$$

wherein n and N are integer values.

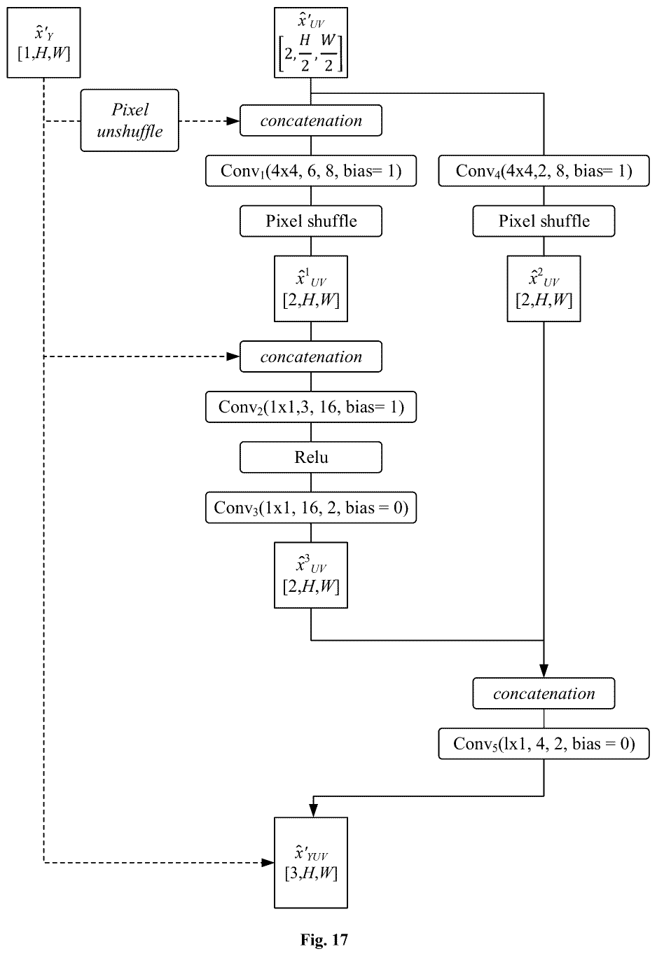

FIG. 17 illustrates an example neural network. The FIG. 17 depicts another implementation of the disclosure.

### EFE Luma Aided Non-Linear Filtering Process

The input of this process are \hat{x}¹_{UV}[2, H, W] and \hat{x}′_{Y}[1, H, W]. Output of this process is \hat{x}²_{UV}[2, H, W].

The multiplicative weight parameters W₃[16] is used.

The additive bias parameter B₂[8] is used.

For x in 0 . . . . W, y in 0 . . . . H, and k in 0 . . . 1 the following is performed:

$${\hat{x}}_{UV}^{{}_{1}} ( k , y , x ) + {\sum }_{n = 0}^{7} {W}_{3} [ 8 * k + n ] * R E L U ( {\hat{x}}_{Y}^{{}_{′}} ( 1 , x , y ) + {B}_{2} [ n ] ) .$$

### 4.3. Explanation and the Benefits of the Examples

The examples improve the quality of a reconstructed image using parameters that are obtained from a bitstream. The examples are designed in such a way that the following benefits are achieved:
1. Some of the parameters that are used in the equation are obtained from the bitstream. This provides the possibility of content adaptation. In neural network-based image compression networks, the network may be trained beforehand using a very large dataset. After the training is complete, the network parameters (e.g. weights and/or bias values) cannot be adjusted. However, when the network is used, it is used on an completely new image that is not part of the training dataset. Therefore, a discrepancy between training dataset and the real-life image exists. In order to solve this problem, a small set of parameters that are optimized for the new image is transmitted to the decoder to improve the adaptation to the new content.
   A second benefit of including the parameters in the bitstream is, when the parameters are transmitted, a much shorter network can be used to serve the same purpose. In other words, if the parameters are transmitted as side information, a much longer neural network (comprising many more convolution and activation layers) might have been necessary to achieve the same purpose.
2. The examples can be implemented using the most basic neural network layers. The equations that are used to explain the examples are designed in such a way that they are implementable using the most fundamental processing layers in the neural network literature, namely convolution and relu operations. The reason for this intentional choice is that, an image coder/decoder is expected to be implemented in a wide variety of devices, including mobile phones. It is important that an image encoded in one device is decodable in nearly all devices. Although the neural processing chipsets or GPUs in such devices are getting more and more sophisticated, it is still not possible to implement an arbitrary function on such processing units. As a simple example, the function ƒ(x)=x², though looking very simple, cannot be efficiently implemented in a neural processing unit and, can only be implemented in a general purpose processing unit such as CPU. If a function is not implementable in neural processing unit, the processing speed and battery consumption is greatly increased.
   The examples eliminate the above problem by using the most fundamental processing layers in neural network literature. The convolution and relu (and some other activation functions like leaky relu, sigmoid etc), are nearly guaranteed to be implemented in neural processing units or GPUs. Therefore, a mobile phone having a neural processing unit or a GPU is expected to perform the defined operation efficiently.
3. The examples utilizes the cross-component information to improve a component of the image. According to the examples, the quality of a component is improved, therefore the reconstructed image is closer to the original image, which is the goal of a good codec. The examples achieve this by utilizing the information included in one component to improve the quality of a second component.

### 4.4. Further Solutions

According to some embodiments of the present disclosure, the input might have a format that is 4:4:4, 4:2:0 or 4:2:2. The format of the picture that is being processed indicates the size ratio between the components of the picture. For example, the 4:4:4 might indicate that the size of the luma component (or primary component) is same as the size of the chroma (or a secondary component). 4:2:2 might indicate that the size of the secondary component might be half of the luma component in one dimension (width or height). 4:2:0 might indicate that the size of the secondary component might be half of the luma component in two dimensions (both width and height).

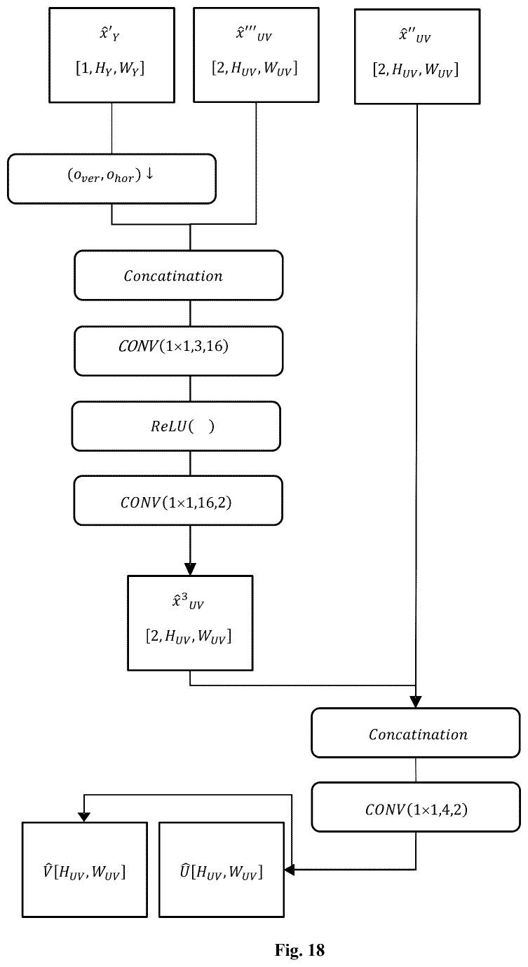

According to some embodiments of the present disclosure, a down-sampling process might be first performed on a primary component. This is exemplified in the FIG. 18 which illustrates a block diagram showing a down-sampling process.

“(oᵥₑᵣ, oₕₒᵣ)↓” indicates a down-sampling operation in horizontal and vertical directions.
oᵥₑᵣ or oₕₒᵣ might indicate a down-sampling ratio in the vertical or horizontal direction.
The down-sampling ratio might be determined by the picture format. Or it might be determined by the ratio of the size of primary component and secondary component.
The down-sampling operation might be a nearest neighbor down-sampling operation. Or it might be an average pooling operation.
Two or one down-sapling ratios might be used. When one down-sampling ratio is used, down-sampling ratios in the horizontal and vertical dimensions might be considered to be equal.
If the picture format is 4:4:4, the down-sampling ratio might be considered to be 1 (no down-sampling).
If the picture format is 4:2:2 the down-sampling ratio might be considered to be 1 in one dimension (horizontal or vertical) and 2 in other dimension.
If the picture format is 4:2:0, the down-sampling ratio might be considered to be 2 in both dimensions.

According to some embodiments of the present disclosure, after the down-sampling is performed on the primary component, it might be further processed by a process according to some embodiments of the present disclosure. An example implementation of some embodiments of the present disclosure is presented as follows.

### Non-Linear Chroma Enhancement Filter

This section details the non-linear filter for of secondary components enhancement.

This process is invoked if EFE_nonlinear_filter_enabled_flag is equal to 1.

The input of this process are \hat{x}′″_{UV}[2, H_{UV}, W_{UV}] as output of ICCI process and \hat{x}″_{UV}[2, H_{UV}, W_{UV}] which is the second output of 14.2 adaptive upsampler process and \hat{x}_{Y}[1, Hy, Wy].

Output of this process are Û [H_{UV}, W_{UV}] and \hat{V}[H_{UV}, W_{UV}].

The following ordered steps are performed:
The parsing process according to parsing table in 9.3.1.4 is invoked to obtain W₃, W₅, numTiles, maxLuma and minLuma.
Non-linear filter parameters tiling process is invoked as described in section 14.3.1 with parsed syntax elements as inputs and Tile2 tensor as output.
The additive bias parameter B₂[8] is obtained as follows, for i=0 . . . numTiles:

$${B}_{2} [ n , i ] = \frac{( n - 8 )}{8} * minLuma [ i ] - \frac{n}{8} * m a x L u m a [ i ] , n = 0 … 7.$$

NLEnable[0] is set equal nonLinear_enabled_U_flag, NLEnable[1] is set equal to nonLinear_enabled_V_flag.

$${\hat{x}}_{Y}^{d}$$

is UUtanou using Ivarest neighbor downsmapling process with \hat{x}′_{Y} as input and (oᵥₑᵣ, oₕₒᵣ) ↓ as down-sampling ratios.
For x=0 . . . . W_{UV}−1, y in 0 . . . . H_{UV}−1, and k in 0 . . . 1 the following is performed:

$${\hat{x}}_{UV}^{3} ( k , y , x ) = {\hat{x}}_{UV}^{{}_{′′′}} ( k , y , x ) + NLEnable [ k ] \cdot {\sum }_{n = 0}^{7} {W}_{3} [ Tile 2 [ y , x ] , k , n ] * REL U ( {\hat{x}}_{Y}^{{}_{d}} ( 0 , x , y ) + {B}_{2} [ n ] ) .$$

For x in 0 . . . . W_{UV}−1, y in 0 . . . . H_{UV}−1 the following is performed:

$$\hat{U} ( y , x ) = {\hat{x}}_{UV}^{{}_{′′}} ( 0 , y , x ) * \frac{{W}_{5} [ \frac{y}{bS} , \frac{x}{b S} , 0 ]}{2} + {\hat{x}}_{UV}^{{}_{3}} ( 0 , y , x ) * ( 1 - \frac{{W}_{5} [ \frac{y}{b S} , \frac{x}{b S} , 0 ]}{2} ) \\ \hat{V} ( y , x ) = {\hat{x}}_{UV}^{{}_{′′}} ( 1 , y , x ) * \frac{{W}_{5} [ \frac{y}{b S} , \frac{x}{b S} , 1 ]}{2} + {\hat{x}}_{UV}^{3} ( 1 , y , x ) * ( 1 - \frac{{W}_{5} [ \frac{y}{b S} , \frac{x}{b S} , 1 ]}{2} )$$

In addition, the nearest neighbour down-sampling process might be implemented as follows.

### Nearest Neighbour Down-Sampling

Denoted with a single down-sampling ratio s ↓ or two down-sampling ratio (s1, s2) ↓. When only a single down-sampling ratio is indicated, s1 and s2 are assumed to be same and equal to s. This layer receives a tensor input of size [C, s1·hₒᵤₜ, s2·wₒᵤₜ] and outputs a tensor output of size [C, hₒᵤₜ, wₒᵤₜ] procedure by which the spatial resolution of each tensor channel decreased.

No interpolation is needed for this down-sampling, just copy:

$$ouput [ c , i , j ] = input [ c , s 1 \cdot i , s 2 \cdot j ] , i = 0 , … , {h}_{i n} - 1 , j = 0 , … , {w}_{i n} - 1 , c = 0 , … , C - 1 .$$

U and V might indicate one of the secondary components.
\hat{x}′_{Y} might indicate a primary component

$${\hat{x}}_{Y}^{d}$$

might indicate the downsampled primary component.
W₃, W₅ might indicate multiplier parameters. They might be parameters of a convolution layer.
RELU indicates are rectified linear unit operation.
NLEnable[0] or NLEnable[1] indicates a flag with values of 0 or 1.
\hat{x}′″_{UV} (k, y, x) indicates the secondary component of a picture.
\hat{x}³_{UV} is an output.
Based on the value of NLEnable, the input \hat{x}′″_{UV} might be output as is, or it might be modified. If the value of NLEnable is equal to 0, the input is not modified (and equal to output).
B₂ are bias values, that are calculated according to 2 values, minLuma and maxLuma. The minLuma and maxLuma might be included in the bitstream.

More details of the embodiments of the present disclosure will be described below which are related to neural network-based visual data coding. As used herein, the term “visual data” may refer to a video, an image, a picture in a video, or any other visual data suitable to be coded.

As discussed above, in the existing design for neural network (NN)-based visual data coding, a format of the output visual data from the decoding process is always a 4:4:4 format, i.e., it is fixed. Therefore, this conventional solution cannot support different output format, and thus lacks flexibility.

To solve the above problems and some other problems not mentioned, visual data processing solutions as described below are disclosed. The embodiments of the present disclosure should be considered as examples to explain the general concepts and should not be interpreted in a narrow way. Furthermore, these embodiments can be applied individually or combined in any manner.

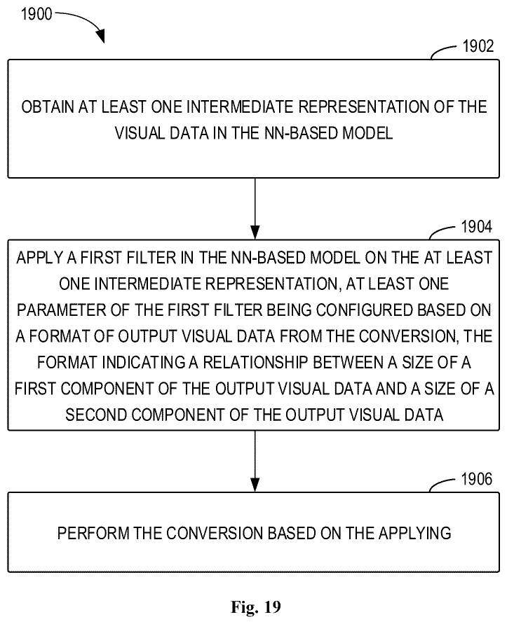

FIG. 19 illustrates a flowchart of a method 1900 for visual data processing in accordance with some embodiments of the present disclosure. The method 1900 may be implemented during a conversion between the visual data and a bitstream of the visual data with a neural network (NN)-based model. As used herein, an NN-based model may be a model based on neural network technologies. For example, an NN-based model may specify sequence of neural network modules (also called architecture) and model parameters. The neural network module may comprise a set of neural network layers. Each neural network layer specifies a tensor operation which receives and outputs tensor, and each layer has trainable parameters. It should be understood that the possible implementations of the NN-based model described here are merely illustrative and therefore should not be construed as limiting the present disclosure in any way.

As shown in FIG. 19, the method 1900 starts at 1902, where at least one intermediate representation of the visual data in the NN-based model is obtained. In some example embodiments, the at least one intermediate representation may be in a pixel domain. In one example embodiment, the at least one intermediate representation of the visual data may be obtained by processing an output of a synthesis transform in the NN-based model. By way of example rather than limitation, one or more filters may be applied on the output of the synthesis transform to obtain the at least one intermediate representation of the visual data. This will be described in detail below. In a further example embodiment, the at least one intermediate representation of the visual data may be obtained by processing a latent representation of the visual data with a synthesis transform in the NN-based model. For example, the at least one intermediate representation may be determined as an output of the synthesis transform. In some alternative example embodiments, the at least one intermediate representation may be in a transformed domain. For example, the at least one intermediate representation may be a latent representation of the visual data. It should be understood that the possible implementations of the at least one intermediate representation described here are merely illustrative and therefore should not be construed as limiting the present disclosure in any way.

At 1904, a first filter in the NN-based model is applied on the at least one intermediate representation. At least one parameter of the first filter being configured based on a format of output visual data from the conversion. This will be described in detail below. By way of example rather than limitation, the first filter may be a non-linear filter, a non-linear chroma enhancement filter, or the like. The scope of the present disclosure is not limited in this respect.

As used herein, the format of output visual data from the conversion may refer to a format of visual data resulted from the conversion (e.g., the output of the entire decoding process). This format may also be referred to as “first format”, “output format”, “output image format” and/or the like. It should also be noted that the term “format” may also be referred to as “color format” or the like. It should be noted that this first format is allowed to be different from a second format for coding the visual data. This second format indicates a format of the output of the synthesis transform and may also be referred to as “coding format”, “coded format”, “coded image format”, “coding mode”, and/or the like. The input of an analysis transform at an encoder side may also be of this second format. Alternatively, the first format may be the same as the second format.

In some embodiments, the first format may be indicated by at least one indication in the bitstream. In this case, the first format may be obtained by parsing the bitstream. Additionally or alternatively, the second format may be indicated by at least one indication in the bitstream. Moreover, the first format may be determined based on the second format or any other suitable coding information for the visual data. Additionally or alternatively, the first format and the second format may be indicated by same indication(s) in the bitstream.

The first format indicates a relationship between a size of a first component of the output visual data and a size of a second component of the output visual data. For example, the first format may indicate a ratio between a vertical size (e.g., height) of the first component and a vertical size (e.g., height) of the second component, and/or a ratio between a horizontal size (e.g., width) of the first component and a horizontal size (e.g., width) of the second component. Similarly, the second format for coding the visual data may indicate a relationship between a size of a first component of the coded visual data and a size of a second component of the coded visual data. For example, the second format may indicate a ratio between a vertical size (e.g., height) of the first component and a vertical size (e.g., height) of the second component, and/or a ratio between a horizontal size (e.g., width) of the first component and a horizontal size (e.g., width) of the second component.

In some embodiments, the first format may be allowed to be a 4:4:4 format, a 4:2:0 format, a 4:2:2 format, or the like. In addition, the second format may be allowed to be a 4:4:4 format, a 4:2:0 format, or a 4:2:2 format, or the like. By way of example, for a 4:4:4 format, the vertical size of the second component may be the same as the vertical size of the first component, and the horizontal size of the second component may be the same as the horizontal size of the first component. For a 4:2:2 format, the vertical size of the second component may be a half of the vertical size of the first component, and the horizontal size of the second component may be the same as the horizontal size of the first component. Alternatively, the vertical size of the second component may be the same as the vertical size of the first component, and the horizontal size of the second component may be a half of the horizontal size of the first component. For a 4:2:0 format, the vertical size of the second component may be a half of the vertical size of the first component, and the horizontal size of the second component may be a half of the horizontal size of the first component. In some embodiments, the first component may comprise one of the following: a primary component, a luma component, or a Y component, and the second component may comprise one of the following: a primary component, a chroma component, a U component, or a V component. It should be understood that the above examples are described merely for purpose of description. The scope of the present disclosure is not limited in this respect.

It is seen that, a ratio between a vertical size of the first component and a vertical size of the second component may be allowed to be 1 or 2, and a ratio between a horizontal size of the first component and a horizontal size of the second component may be allowed to be 1 or 2. It should be understood that the specific values recited herein are intended to be exemplary rather than limiting the scope of the present disclosure.

At 1906, the conversion is performed based on the applying. In some embodiments, the conversion may include encoding the visual data into the bitstream. Additionally or alternatively, the conversion may include decoding the visual data from the bitstream. It should be understood that the above illustrations are described merely for purpose of description. The scope of the present disclosure is not limited in this respect.

In view of the above, a parameter(s) of a first filter applied on the at least one intermediate representation of the visual data is configured based on a format of the output visual data. Compared with the conventional solution where the parameter of the first filter is fixed, the proposed solution can advantageously support different output format, so as to cater different applications. Thereby, the coding flexibility can be improved and thus the coding efficiency can be enhanced.

In some embodiments, in the first filter, a first intermediate result may be obtained using a downsampling process with a first intermediate representation in the at least one intermediate representation as input and at least one down-sampling ratio. By way of example rather than limitation, the downsampling process may comprise a nearest neighbor downsampling process, which has been described in detail in the above section. Additionally or alternatively, the downsampling process may comprise an average pooling operation. It should be understood that the possible implementations of the downsampling process described here are merely illustrative and therefore should not be construed as limiting the present disclosure in any way.

In some embodiments, the first intermediate representation may be associated with the first component. In the example shown in FIG. 18, the first intermediate representation is denoted as x′y and associated with the Y component. The at least one down-sampling ratio for the downsampling process may be configured based on the first format. That is, the above-mentioned at least one parameter of the first filter may comprise at least one down-sampling ratio for the downsampling process.

In some embodiments, the at least one down-sampling ratio may comprise a first downsampling ratio in a vertical direction and/or a second downsampling ratio in a horizontal direction. For example, the relationship indicated by the first format may comprise a first ratio between a vertical size of the first component of the output visual data and a vertical size of the second component of the output visual data. Moreover, the first downsampling ratio may be determined based on the first ratio. By way of example, the first downsampling ratio may be set equal to the first ratio, or the first downsampling ratio may be a function of the first ratio.

Additionally or alternatively, the relationship may comprise a second ratio between a horizontal size of the first component of the output visual data and a horizontal size of the second component of the output visual data. Moreover, the second downsampling ratio may be determined based on the second ratio. By way of example, the second downsampling ratio may be set equal to the second ratio, or the second downsampling ratio may be a function of the second ratio.

In some embodiments, if the first format is a 4:4:4 format, the first downsampling ratio may be equal to 1, and the second downsampling ratio may be equal to 1. If the first format is a 4:2:2 format, one of the first and second downsampling ratios may be equal to 1, and a further one the first and second downsampling ratios may be equal to 2. If the first format is a 4:2:0 format, the first downsampling ratio may be equal to 2, and the second downsampling ratio may be equal to 2. It should be understood that the above examples are described merely for purpose of description. The scope of the present disclosure is not limited in this respect.

In some embodiments, a second intermediate result may be generated by applying a first subnetwork of the first filter on a second intermediate representation in the at least one intermediate representation and the first intermediate result. For example, the first subnetwork may comprise a concatenation operation, a convolution layer, a rectified linear unit (ReLU), and/or the like. By way of example rather than limitation, the second intermediate representation may be associated with the second component. In one example embodiment, the second intermediate representation may be an output of an inter channel correlation information (ICCI) filter in the NN-based filter. In the example shown in FIG. 18, the second intermediate representation may be denoted as \hat{x}′″_{UV} and associated with the U and V components. The second intermediate result may be denoted as \hat{x}³_{UV}.

In addition, an output of the first filter may be generated by applying a second subnetwork of the first filter on a third intermediate representation in the at least one intermediate representation and the second intermediate result. For example, the second subnetwork may comprise a concatenation operation and/or a convolution layer. By way of example rather than limitation, the third intermediate representation may be associated with the second component. In one example embodiment, the third intermediate representation may be an output of an adaptive filter in the NN-based filter. In the example shown in FIG. 18, the third intermediate representation may be denoted as \hat{x}″_{UV} and associated with the U and V components.

In view of the above, the solutions in accordance with some embodiments of the present disclosure can advantageously support different output format, so as to cater different applications. Thereby, the coding flexibility can be improved and thus the coding efficiency can be enhanced.

According to further embodiments of the present disclosure, a non-transitory computer-readable recording medium is provided. The non-transitory computer-readable recording medium stores a bitstream of visual data which is generated by a method performed by an apparatus for visual data processing. The method comprises: obtaining at least one intermediate representation of the visual data in a neural network (NN)-based model; applying a first filter in the NN-based model on the at least one intermediate representation, at least one parameter of the first filter being configured based on a format of output visual data from the conversion, the format indicating a relationship between a size of a first component of the output visual data and a size of a second component of the output visual data; and generating the bitstream with the NN-based model based on the applying.

According to still further embodiments of the present disclosure, a method for storing bitstream of visual data is provided. The method comprises: obtaining at least one intermediate representation of the visual data in a neural network (NN)-based model; applying a first filter in the NN-based model on the at least one intermediate representation, at least one parameter of the first filter being configured based on a format of output visual data from the conversion, the format indicating a relationship between a size of a first component of the output visual data and a size of a second component of the output visual data; generating the bitstream with the NN-based model based on the applying; and storing the bitstream in a non-transitory computer-readable recording medium.

Implementations of the present disclosure can be described in view of the following clauses, the features of which can be combined in any reasonable manner.
Clause 1. A method for visual data processing, comprising: obtaining, for a conversion between visual data and a bitstream of the visual data with a neural network (NN)-based model, at least one intermediate representation of the visual data in the NN-based model; applying a first filter in the NN-based model on the at least one intermediate representation, at least one parameter of the first filter being configured based on a format of output visual data from the conversion, the format indicating a relationship between a size of a first component of the output visual data and a size of a second component of the output visual data; and performing the conversion based on the applying.
Clause 2. The method of clause 1, wherein in the first filter, a first intermediate result is obtained using a downsampling process with a first intermediate representation in the at least one intermediate representation as input, and the at least one parameter comprises at least one down-sampling ratio for the downsampling process.
Clause 3. The method of clause 2, wherein the first intermediate representation is associated with the first component.
Clause 4. The method of any of clauses 2-3, wherein the at least one down-sampling ratio comprises at least one of the following: a first downsampling ratio in a vertical direction, or a second downsampling ratio in a horizontal direction.
Clause 5. The method of clause 4, wherein the relationship comprises a first ratio between a vertical size of the first component of the output visual data and a vertical size of the second component of the output visual data, and the first downsampling ratio is determined based on the first ratio.
Clause 6. The method of any of clauses 4-5, wherein the relationship comprises a second ratio between a horizontal size of the first component of the output visual data and a horizontal size of the second component of the output visual data, and the second downsampling ratio is determined based on the second ratio.
Clause 7. The method of any of clauses 4-6, wherein if the format is a 4:4:4 format, the first downsampling ratio is equal to 1, and the second downsampling ratio is equal to 1, or if the format is a 4:2:2 format, one of the first and second downsampling ratios is equal to 1, and a further one the first and second downsampling ratios is equal to 2, or if the format is a 4:2:0 format, the first downsampling ratio is equal to 2, and the second downsampling ratio is equal to 2.
Clause 8. The method of any of clauses 2-7, wherein a second intermediate result is generated by applying a first subnetwork of the first filter on a second intermediate representation in the at least one intermediate representation and the first intermediate result.
Clause 9. The method of clause 8, wherein the first subnetwork comprises at least one of the following: a concatenation operation, a convolution layer, or a rectified linear unit (ReLU).
Clause 10. The method of any of clauses 8-9, wherein the second intermediate representation is associated with the second component and is an output of an inter channel correlation information (ICCI) filter in the NN-based filter.
Clause 11. The method of any of clauses 8-10, wherein an output of the first filter is generated by applying a second subnetwork of the first filter on a third intermediate representation in the at least one intermediate representation and the second intermediate result.
Clause 12. The method of clause 11, wherein the second subnetwork comprises at least one of the following: a concatenation operation, or a convolution layer.
Clause 13. The method of any of clauses 11-12, wherein the third intermediate representation is associated with the second component and is an output of an adaptive filter in the NN-based filter.
Clause 14. The method of any of clauses 2-13, wherein the downsampling process comprises a nearest neighbor downsampling process.
Clause 15. The method of any of clauses 1-14, wherein the first component comprises one of the following: a primary component, a luma component, or a Y component, and the second component comprises one of the following: a primary component, a chroma component, a U component, or a V component.
Clause 16. The method of any of clauses 1-15, wherein the format is indicated by at least one indication in the bitstream.
Clause 17. The method of any of clauses 1-16, wherein the format is allowed to be one of the following: a 4:4:4 format, a 4:2:0 format, or a 4:2:2 format.
Clause 18. The method of any of clauses 1-17, wherein the first filter comprises a non-linear filter.
Clause 19. The method of any of clauses 1-18, wherein the at least one intermediate representation of the visual data is obtained by processing an output of a synthesis transform in the NN-based model.
Clause 20. The method of any of clauses 1-18, wherein the at least one intermediate representation of the visual data is obtained by processing a latent representation of the visual data with a synthesis transform in the NN-based model.
Clause 21. The method of any of clauses 2-20, wherein the downsampling process comprises an average pooling operation.
Clause 22. The method of any of clauses 1-21, wherein the visual data comprise a video, a picture of the video, or an image.
Clause 23. The method of any of clauses 1-22, wherein the conversion includes encoding the visual data into the bitstream.
Clause 24. The method of any of clauses 1-22, wherein the conversion includes decoding the visual data from the bitstream.
Clause 25. An apparatus for visual data processing comprising a processor and a non-transitory memory with instructions thereon, wherein the instructions upon execution by the processor, cause the processor to perform a method in accordance with any of clauses 1-24.
Clause 26. A non-transitory computer-readable storage medium storing instructions that cause a processor to perform a method in accordance with any of clauses 1-24.
Clause 27. A non-transitory computer-readable recording medium storing a bitstream of visual data which is generated by a method performed by an apparatus for visual data processing, wherein the method comprises: obtaining at least one intermediate representation of the visual data in a neural network (NN)-based model; applying a first filter in the NN-based model on the at least one intermediate representation, at least one parameter of the first filter being configured based on a format of output visual data from the conversion, the format indicating a relationship between a size of a first component of the output visual data and a size of a second component of the output visual data; and generating the bitstream with the NN-based model based on the applying.
Clause 28. A method for storing a bitstream of visual data, comprising: obtaining at least one intermediate representation of the visual data in a neural network (NN)-based model; applying a first filter in the NN-based model on the at least one intermediate representation, at least one parameter of the first filter being configured based on a format of output visual data from the conversion, the format indicating a relationship between a size of a first component of the output visual data and a size of a second component of the output visual data; generating the bitstream with the NN-based model based on the applying; and storing the bitstream in a non-transitory computer-readable recording medium.

### Example Device

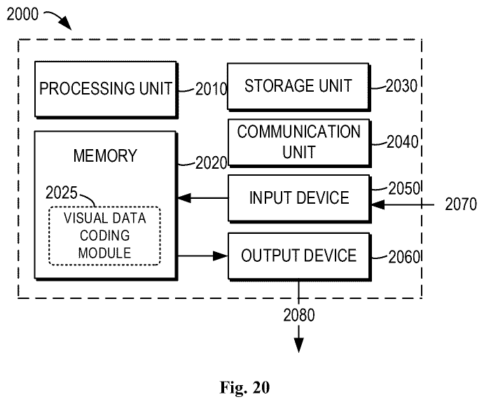

FIG. 20 illustrates a block diagram of a computing device 2000 in which various embodiments of the present disclosure can be implemented. The computing device 2000 may be implemented as or included in the source device 110 (or the visual data encoder 114) or the destination device 120 (or the visual data decoder 124).

It would be appreciated that the computing device 2000 shown in FIG. 20 is merely for purpose of illustration, without suggesting any limitation to the functions and scopes of the embodiments of the present disclosure in any manner.

As shown in FIG. 20, the computing device 2000 includes a general-purpose computing device 2000. The computing device 2000 may at least comprise one or more processors or processing units 2010, a memory 2020, a storage unit 2030, one or more communication units 2040, one or more input devices 2050, and one or more output devices 2060.

In some embodiments, the computing device 2000 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 2000 can support any type of interface to a user (such as “wearable” circuitry and the like).

The processing unit 2010 may be a physical or virtual processor and can implement various processes based on programs stored in the memory 2020. In a multi-processor system, multiple processing units execute computer executable instructions in parallel so as to improve the parallel processing capability of the computing device 2000. The processing unit 2010 may also be referred to as a central processing unit (CPU), a microprocessor, a controller or a microcontroller.

The computing device 2000 typically includes various computer storage medium. Such medium can be any medium accessible by the computing device 2000, including, but not limited to, volatile and non-volatile medium, or detachable and non-detachable medium. The memory 2020 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 2030 may be any detachable or non-detachable medium and may include a machine-readable medium such as a memory, flash memory drive, magnetic disk or another other media, which can be used for storing information and/or visual data and can be accessed in the computing device 2000.

The computing device 2000 may further include additional detachable/non-detachable, volatile/non-volatile memory medium. Although not shown in FIG. 20, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more visual data medium interfaces.

The communication unit 2040 communicates with a further computing device via the communication medium. In addition, the functions of the components in the computing device 2000 can be implemented by a single computing cluster or multiple computing machines that can communicate via communication connections. Therefore, the computing device 2000 can operate in a networked environment using a logical connection with one or more other servers, networked personal computers (PCs) or further general network nodes.

The input device 2050 may be one or more of a variety of input devices, such as a mouse, keyboard, tracking ball, voice-input device, and the like. The output device 2060 may be one or more of a variety of output devices, such as a display, loudspeaker, printer, and the like. By means of the communication unit 2040, the computing device 2000 can further communicate with one or more external devices (not shown) such as the storage devices and display device, with one or more devices enabling the user to interact with the computing device 2000, or any devices (such as a network card, a modem and the like) enabling the computing device 2000 to communicate with one or more other computing devices, if required. Such communication can be performed via input/output (I/O) interfaces (not shown).

In some embodiments, instead of being integrated in a single device, some or all components of the computing device 2000 may also be arranged in cloud computing architecture. In the cloud computing architecture, the components may be provided remotely and work together to implement the functionalities described in the present disclosure. In some embodiments, cloud computing provides computing, software, visual data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding visual data may be stored on a server at a remote position. The computing resources in the cloud computing environment may be merged or distributed at locations in a remote visual data center. Cloud computing infrastructures may provide the services through a shared visual data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 2000 may be used to implement visual data encoding/decoding in embodiments of the present disclosure. The memory 2020 may include one or more visual data coding modules 2025 having one or more program instructions. These modules are accessible and executable by the processing unit 2010 to perform the functionalities of the various embodiments described herein.

In the example embodiments of performing visual data encoding, the input device 2050 may receive visual data as an input 2070 to be encoded. The visual data may be processed, for example, by the visual data coding module 2025, to generate an encoded bitstream. The encoded bitstream may be provided via the output device 2060 as an output 2080.

In the example embodiments of performing visual data decoding, the input device 2050 may receive an encoded bitstream as the input 2070. The encoded bitstream may be processed, for example, by the visual data coding module 2025, to generate decoded visual data. The decoded visual data may be provided via the output device 2060 as the output 2080.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for visual data processing, comprising:
obtaining, for a conversion between visual data and a bitstream of the visual data with a neural network (NN)-based model, at least one intermediate representation of the visual data in the NN-based model;
applying a first filter in the NN-based model on the at least one intermediate representation, at least one parameter of the first filter being configured based on a format of output visual data from the conversion, the format indicating a relationship between a size of a first component of the output visual data and a size of a second component of the output visual data; and
performing the conversion based on the applying.

2. The method of claim 1, wherein in the first filter, a first intermediate result is obtained using a downsampling process with a first intermediate representation in the at least one intermediate representation as input, and the at least one parameter comprises at least one down-sampling ratio for the downsampling process.

3. The method of claim 2, wherein the first intermediate representation is associated with the first component.

4. The method of claim 2, wherein the at least one down-sampling ratio comprises at least one of the following:
a first downsampling ratio in a vertical direction, or
a second downsampling ratio in a horizontal direction.

5. The method of claim 4, wherein the relationship comprises a first ratio between a vertical size of the first component of the output visual data and a vertical size of the second component of the output visual data, and the first downsampling ratio is determined based on the first ratio.

6. The method of claim 4, wherein the relationship comprises a second ratio between a horizontal size of the first component of the output visual data and a horizontal size of the second component of the output visual data, and the second downsampling ratio is determined based on the second ratio.

7. The method of claim 4, wherein if the format is a 4:4:4 format, the first downsampling ratio is equal to 1, and the second downsampling ratio is equal to 1, or
if the format is a 4:2:2 format, one of the first and second downsampling ratios is equal to 1, and a further one the first and second downsampling ratios is equal to 2, or
if the format is a 4:2:0 format, the first downsampling ratio is equal to 2, and the second downsampling ratio is equal to 2.

8. The method of claim 2, wherein a second intermediate result is generated by applying a first subnetwork of the first filter on a second intermediate representation in the at least one intermediate representation and the first intermediate result.

9. The method of claim 8, wherein the first subnetwork comprises at least one of the following:
a concatenation operation,
a convolution layer, or
a rectified linear unit (ReLU).

10. The method of claim 8, wherein the second intermediate representation is associated with the second component and is an output of an inter channel correlation information (ICCI) filter in the NN-based filter.

11. The method of claim 8, wherein an output of the first filter is generated by applying a second subnetwork of the first filter on a third intermediate representation in the at least one intermediate representation and the second intermediate result.

12. The method of claim 11, wherein the second subnetwork comprises at least one of the following:
a concatenation operation, or
a convolution layer.

13. The method of claim 11, wherein the third intermediate representation is associated with the second component and is an output of an adaptive filter in the NN-based filter.

14. The method of claim 2, wherein the downsampling process comprises a nearest neighbor downsampling process.

15. The method of claim 1, wherein the first component comprises one of the following: a primary component, a luma component, or a Y component, and the second component comprises one of the following: a primary component, a chroma component, a U component, or a V component, or
wherein the format is indicated by at least one indication in the bitstream, or
wherein the format is allowed to be one of the following: a 4:4:4 format, a 4:2:0 format, or a 4:2:2 format, or
wherein the first filter comprises a non-linear filter, or
wherein the at least one intermediate representation of the visual data is obtained by processing an output of a synthesis transform in the NN-based model, or
wherein the at least one intermediate representation of the visual data is obtained by processing a latent representation of the visual data with a synthesis transform in the NN-based model, or wherein the visual data comprise a video, a picture of the video, or an image.

16. The method of claim 1, wherein the conversion includes encoding the visual data into the bitstream.

17. The method of claim 1, wherein the conversion includes decoding the visual data from the bitstream.

18. The method of claim 1, wherein the conversion comprises: generating the bitstream from the visual data, and
the method further comprises: storing the bitstream in a non-transitory computer-readable recording medium.

19. An apparatus for visual data processing comprising a processor and a non-transitory memory with instructions thereon, wherein the instructions upon execution by the processor, cause the processor to perform operations comprising:
obtaining, for a conversion between visual data and a bitstream of the visual data with a neural network (NN)-based model, at least one intermediate representation of the visual data in the NN-based model;
applying a first filter in the NN-based model on the at least one intermediate representation, at least one parameter of the first filter being configured based on a format of output visual data from the conversion, the format indicating a relationship between a size of a first component of the output visual data and a size of a second component of the output visual data; and
performing the conversion based on the applying.

20. A non-transitory computer-readable storage medium storing instructions that cause a processor to perform operations comprising:
obtaining, for a conversion between visual data and a bitstream of the visual data with a neural network (NN)-based model, at least one intermediate representation of the visual data in the NN-based model;
applying a first filter in the NN-based model on the at least one intermediate representation, at least one parameter of the first filter being configured based on a format of output visual data from the conversion, the format indicating a relationship between a size of a first component of the output visual data and a size of a second component of the output visual data; and
performing the conversion based on the applying.
